(19) United States
(12) Patent Application Publication
(10) Pub. No.: US 2020/0331285 A1
(43) Pub. Date: Oct. 22, 2020

(54) PROJECTABLE AND RETRACTABLE WRITING TOOL AND MULTI-TIP WRITING TOOL

(71) Applicant: KABUSHIKI KAISHA PILOT CORPORATION (also trading as PILOT CORPORATION), Tokyo (JP)

(72) Inventor: Yoshihito KOZAKI, TOKYO (JP)

(21) Appl. No.: 16/955,242

(22) PCT Filed: Dec. 18, 2018
(86) PCT No.: PCT/JP2018/046507

§ 371 Date: Jun. 18, 2020

(30) Foreign Application Priority Data
Dec. 20, 2017 (JP) 2017-244446
Dec. 20, 2017 (JP) 2017-244447
Dec. 20, 2017 (JP) 2017-244448

(51) Int. Cl. B43K 7/12; B43K 24/08; B43K 24/12

(52) U.S. Cl. CPC B43K 7/12; B43K 24/12; B43K 24/08

(57) ABSTRACT

The present invention includes a shaft cylinder having an opening at a front end thereof, a tip holder movable in an axial direction of the shaft cylinder, a tip projectable and retractable in conjunction with a movement of the tip holder, an annular member fitted on the tip holder and axially movable, and an elastic member connecting the tip holder and the annular member so that they are movable relatively to each other. A contact surface tapered toward the front end is formed on an outer periphery of the annular member. A cutout reduces an inner diameter of the annular when a load is received by the contact surface. A guide surface is formed on the part of the inside surface of the shaft cylinder. The contact surface receives the load from the guide surface in conjunction with the movement of the tip holder toward the front end side.

### TECHNICAL FIELD

The present invention pertains to a projectable and retractable writing tool which is projectable and retractable through an opening of a shaft cylinder in conjunction with a movement of a tip holder. In addition, the present invention pertains to a multi-tip (multi-core) writing tool. In particular, the present invention pertains to a multi-tip writing tool which is capable of containing a plurality of writing tips in a shaft cylinder.

### BACKGROUND ART

JP-U-H05-85683 (Patent Document 1) discloses an anti-sway device for a leading edge of a writing tool. In the structure of the anti-sway device, a concave groove is provided at a suitable position of the leading edge of the writing tool, and an elastic O-ring, whose outer diameter is almost the same as an inner diameter of a leading edge of a shaft cylinder, is fitted into the concave groove. According to this anti-sway device, in a pencil type or knock type of writing tool, rattling sound, which may be caused by a contact between the leading edge of the writing tool and a leading-edge hole of the leading edge of the shaft cylinder at the time of writing, can be prevented.

JP-U-H05-93884 (Patent Document 2) also discloses an anti-sway device for a leading edge of a writing tool. In the structure of the anti-sway device, an engagement step is provided at a leading edge of a shaft cylinder, and an elastic ring, whose inner diameter is slightly smaller than an outer diameter of the leading edge of the writing tool, is engaged with the engagement step. According to this anti-sway device, since the elastic ring locks the leading edge of the writing tool, rattling at the time of writing can be prevented even if there is a gap between a leading-edge inner diameter of the shaft cylinder and the leading edge of the writing tool.

JP-A-2013-220602 (Patent Document 3) discloses a multi-tip writing tool in which each writing element is slidable in a front and rear direction with respect to a shaft cylinder and a writing tip of each writing element is projectable through an opening of the shaft cylinder. An annular member is arranged around an outer periphery of a leading edge portion of each writing element, and an inside surface of the shaft cylinder in the vicinity of the opening is provided with a substantially spherical surface with which the annular member can come into contact. The annular member is fixed to the corresponding writing element via a spring, and thus is biased forward. When the writing element is projected, the annular member closely contacts with the inside surface of the shaft cylinder because of an elastic force of the spring. Thus, rattling at the time of writing can be prevented.

### PRIOR ART DOCUMENT

### Patent Document List

Patent Document 1 recited in the present specification is JP-U-H05-85683. Patent Document 2 recited in the present specification is JP-U-H05-93884. Patent Document 3 recited in the present specification is JP-A-2013-220602.

### SUMMARY OF INVENTION

### Technical Problem

According to the technique disclosed in JP-U-H05-85683(Patent Document 1) and JP-U-H05-93884 (Patent Document 2), the O-ring or ring is so radially deformable that the effect of preventing the rattling may be not sufficient. In addition, the writing tip may stick to the O-ring or ring, which may deteriorate a smooth retracting movement of the writing tip that has been projected.

On the other hand, according to the technique disclosed in JP-A-2013-220602 (Patent Document 3), in order to enhance the effect of preventing the rattling at the time of writing, it is necessary to properly manage a dimensional relationship between an inside surface of the annular member and an outer periphery surface of the writing tip. For example, if a gap size between the outer periphery surface of the writing tip and the inside surface of the annular member is larger than a gap size between the outer periphery surface of the writing tip and an inside surface of a leading edge portion of the shaft cylinder, the effect of preventing the rattling at the time of writing cannot be obtained. Thus, high dimensional precision is required, which may be a problem in productivity.

The present invention has been made based on the above findings. The object of the present invention is to provide a projectable and retractable writing tool and a multi-tip writing tool which can prevent rattling of a tip at the time of writing and thus can achieve a stable writing feeling without requiring a high-precision dimension management for parts.

### Solution to Problem

The first invention is a projectable and retractable writing tool comprising: a shaft cylinder having an opening at a front end thereof, a tip holder contained in an inside of the shaft cylinder and movable in an axial direction of the shaft cylinder, a tip fixed to a front end of the tip holder to be projectable and retractable through the opening of the shaft cylinder in conjunction with a movement of the tip holder, an annular member loosely fitted onto an outer periphery of the tip holder or the tip to be movable in an axial direction of the tip holder or the tip with respect to the tip holder or the tip, and an elastic member connecting the tip holder and the annular member such that the tip holder and the annular member are movable relatively to each other, wherein a contact surface is formed on at least a part of an outer periphery of the annular member, the contact surface being configured to come into contact with a part of an inside surface of the shaft cylinder in conjunction with a movement of the tip holder toward a front end side thereof, a cutout is formed at a part of the annular member such that an inner diameter of the annular member is reduced when a load is received by the contact surface, a guide surface is formed on the part of the inside surface of the shaft cylinder, the guide surface being configured to come into contact with the contact surface in conjunction with the movement of the tip holder toward the front end side, and the contact surface is configured to receive the load from the guide surface in conjunction with the movement of the tip holder toward the front end side.

According to the first invention, the contact surface of the annular member receives the load from the guide surface of the shaft cylinder in conjunction with the movement of the tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the tip holder and the annular member are connected via the elastic member such that the tip holder and the annular member are movable relatively to each other, it can be assured that the tip or the tip holder can be effectively grasped in a rattling-free (play-free) manner even if no high-precision dimension management is applied to a degree of reduction of the inner diameter of the annular member or the like.

Preferably, the cutout is a plurality of cutout elements arranged at regular intervals in a circumferential direction of the annular member, and each of the plurality of cutout elements is a slit extending in an axial direction of the annular member. In this case, the inner diameter of the annular member can be reduced in a circumferentially well-balanced manner.

Preferably, the contact surface has a tapered shape toward the front end side, and the guide surface also has a tapered shape toward the front end side. Preferably, the contact surface has a frustoconical surface, for example. In this case, preferably, the guiding surface is a concave frustoconical surface. Alternatively, preferably, the contact surface has a convex curved surface which is rotationally symmetric about an axis. In this case, preferably, the guiding surface is a concave curved surface or a concave frustoconical surface which is also rotationally symmetric about an axis but has a curvature gentler than that of the convex curved surface.

In addition, preferably, the elastic member is a coil spring. Alternatively, preferably, the elastic member is a tubular resin spring member having a lot of splits each of which extends in a direction perpendicular to the axial direction. In the latter case, the annular member and the tubular resin spring member may be integrally molded of the same resin material.

In addition, preferably, the elastic member and the tip holder may be connected via an annular collar. In this case, preferably, the elastic member and the annular collar are fixed to each other, and the annular collar and the shaft cylinder are fixed to each other via a second elastic member. According to this feature, the tip holder and the annular collar need not to be fixed, and thus existing refills for replacement including conventional tip holders may be used. In addition, in this configuration, an amount of displacement of the second elastic member in conjunction with the movement of the tip holder is larger than an amount of displacement of the elastic member in conjunction with the movement of the tip holder.

In addition, the first invention is also applicable to only a shaft cylinder for a projectable and retractable writing tool. That is to say, the present invention is a shaft cylinder for a projectable and retractable writing tool, the shaft cylinder being capable of containing a tip holder such that the tip holder is movable in an axial direction, a tip being fixed to a front end of the tip holder, the shaft cylinder having an opening at a front end thereof, through which the tip is projectable and retractable in conjunction with a movement of the tip holder, the shaft cylinder comprising; an annular member loosely fitted onto an outer periphery of the tip holder or the tip in a state wherein the shaft cylinder contains the tip holder, to be movable in an axial direction of the tip holder or the tip with respect to the tip holder or the tip while being loosely fitted, an annular collar connected to the annular member via an elastic member, the annular collar being capable of coming into contact with the tip holder in conjunction with a movement of the tip holder toward a front end side thereof, and a second elastic member configured to support the annular collar on an inside surface of the shaft cylinder, wherein a contact surface is formed on at least a part of an outer periphery of the annular member, the contact surface being tapered toward a front end thereof, a cutout being formed at a part of the annular member such that an inner diameter of the annular member is reduced when a load is received by the contact surface, a guide surface being formed on a part of an inside surface of the shaft cylinder, the guide surface being tapered toward a front end thereof, and the contact surface being configured to receive the load from the guide surface in conjunction with a movement of the tip holder toward a front end side thereof.

The second invention is a multi-tip writing tool comprising: a shaft cylinder having an opening at a front end thereof, a plurality of tip holders contained in an inside of the shaft cylinder and movable in an axial direction of the shaft cylinder, a tip fixed to a front end of each of the plurality of tip holders to be projectable and retractable through the opening of the shaft cylinder in conjunction with a movement of the corresponding tip holder, an annular member loosely fitted onto an outer periphery of each tip or each tip holder fixed to each tip to be movable in an axial direction of the tip with respect to the tip, and an elastic member connecting the tip holder and the annular member such that the tip holder and the annular member are movable relatively to each other, wherein a contact surface is formed on at least a part of an outer periphery of the annular member, the contact surface being configured to come into contact with a part of an inside surface of the shaft cylinder in conjunction with a movement of the tip holder connected to the annular member toward a front end side thereof, a cutout is formed at a part of the annular member such that an inner diameter of the annular member is reduced when a load is received by the contact surface, a guide surface is formed on the part of the inside surface of the shaft cylinder, the guide surface being configured to come into contact with the contact surface in conjunction with the movement of the tip holder toward the front end side, and the contact surface is configured to receive the load from the guide surface in conjunction with the movement of the tip holder connected to the annular member having the contact surface toward the front end side.

According to the second invention, the contact surface of the annular member receives the load from the guide surface of the shaft cylinder in conjunction with the movement of the tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the tip holder and the annular member are connected via the elastic member such that the tip holder and the annular member are movable relatively to each other, it can be assured that the tip or the tip holder can be effectively grasped in a rattling-free (play-free) manner even if no high-precision dimension management is applied to a degree of reduction of the inner diameter of the annular member or the like.

Preferably, the cutout is a plurality of cutout elements arranged at regular intervals in a circumferential direction of the annular member, and each of the plurality of cutout elements is a slit extending in an axial direction of the annular member. In this case, the inner diameter of the annular member can be reduced in a circumferentially well-balanced manner.

Preferably, the contact surface has a tapered shape toward the front end side, and the guide surface also has a tapered shape toward the front end side. Preferably, the contact surface has a frustoconical surface, for example. In this case, preferably, the guiding surface is a concave frustoconical surface. Alternatively, preferably, the contact surface has a convex curved surface which is rotationally symmetric about an axis. In this case, preferably, the guiding surface is a concave curved surface or a concave frustoconical surface which is also rotationally symmetric about an axis but has a curvature gentler than that of the convex curved surface.

In addition, preferably, the elastic member is a tubular resin spring member having a lot of splits each of which extends in a direction perpendicular to the axial direction. In this case, further preferably, the annular member and the tubular resin spring member are integrally molded of the same resin material.

In addition, preferably, one of the plurality of tip holders holds a friction member as a tip. The friction member means an eraser or a frictional heat generating rubber for a thermochromic writing tool (a rubber for erasing). In this case, it is possible to prevent rattling of the friction member when erasing a written trace, and thus to obtain a more stable erasing feeling.

In addition, preferably, an operation element having an operation part is provided on a rear end side of each tip holder, a plurality of window holes, each of which extends in a front and rear direction, are distributed and provided at a side wall of the shaft cylinder in radial directions, the operational part of each operational element is projected radially outward from a corresponding window hole, a locking wall is provided in the shaft cylinder, the locking wall being capable of locking a part of an operation element when the operation part of the operation element is operated to slide forward, a plurality of coil springs configured to respectively bias the plurality of tip holders rearward is provided in the shaft cylinder, front end sides of the plurality of coil springs are supported by a spring supporter fixed to the shaft cylinder, and the spring supporter is provided with a plurality of inside holes through which the plurality of tip holders can be inserted respectively.

The third invention is a multi-tip writing tool comprising: a shaft cylinder having an opening at a front end thereof, a plurality of tip holders contained in an inside of the shaft cylinder and movable in an axial direction of the shaft cylinder, a tip fixed to a front end of each of the plurality of tip holders to be projectable and retractable through the opening of the shaft cylinder in conjunction with a movement of the corresponding tip holder, an annular member capable of being loosely fitted on an outer periphery of one tip holder among the plurality of tip holders or one tip fixed to the one tip holder in conjunction with a movement of the one tip holder toward a front end side thereof to be movable in an axial direction of the one tip holder or the one tip with respect to the one tip holder or the one tip while being loosely fitted, an annular collar connected to the annular member via an elastic member, the annular collar being capable of coming into contact with the one tip holder in conjunction with the movement of the one tip holder toward the front end side, and a second elastic member configured to support the annular collar on an inside surface of the shaft cylinder, wherein a contact surface is formed on at least a part of an outer periphery of the annular member, the contact surface being configured to come into contact with a part of an inside surface of the shaft cylinder when the annular member is moved toward the front end side via the annular collar and the elastic member in conjunction with the movement of the one tip holder toward the front end side, a cutout is formed at a part of the annular member such that an inner diameter of the annular member is reduced when a load is received by the contact surface, a guide surface is formed on the part of the inside surface of the shaft cylinder, the guide surface being configured to come into contact with the contact surface in conjunction with the movement of the one tip holder toward the front end side, and the contact surface is configured to receive the load from the guide surface when the annular member is moved toward the front end side via the annular collar and the elastic member in conjunction with the movement of the one tip holder toward the front end side.

According to the third invention, the contact surface of the annular member receives the load from the guide surface of the shaft cylinder when the annular member is moved toward the front end side via the annular collar and the elastic member in conjunction with the movement of the one tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the annular collar abutted by the tip holder and the annular member are connected via the elastic member, it can be assured that the tip or the tip holder can be effectively grasped in a rattling-free (play-free) manner even if no high-precision dimension management is applied to a degree of reduction of the inner diameter of the annular member or the like.

Preferably, the cutout is a plurality of cutout elements arranged at regular intervals in a circumferential direction of the annular member, and each of the plurality of cutout elements is a slit extending in an axial direction of the annular member. In this case, the inner diameter of the annular member can be reduced in a circumferentially well-balanced manner.

Preferably, the contact surface has a tapered shape toward the front end side, and the guide surface also has a tapered shape toward the front end side. Preferably, the contact surface has a frustoconical surface, for example. In this case, preferably, the guiding surface is a concave frustoconical surface. Alternatively, preferably, the contact surface has a convex curved surface which is rotationally symmetric about an axis.. In this case, preferably, the guiding surface is a concave curved surface or a concave frustoconical surface which is also rotationally symmetric about an axis but has a curvature gentler than that of the convex curved surface.

In addition, preferably, the elastic member is a tubular resin spring member having a lot of splits each of which extends in a direction perpendicular to the axial direction. In this case, further preferably, the annular member, the tubular resin spring member and the annular collar are integrally molded of the same resin material.

In addition, preferably, one of the plurality of tip holders holds a friction member as a tip. The friction member means an eraser or a frictional heat generating rubber for a thermochromic writing tool (a rubber for erasing). In this case, it is possible to prevent rattling of the friction member when erasing a written trace, and thus to obtain a more stable erasing feeling.

In addition, the third invention is also applicable to only a shaft cylinder for a multi-tip writing tool. That is to say, the present invention is a shaft cylinder for a multi-tip writing tool, the shaft cylinder being capable of containing a plurality of tip holders such that each tip holder is movable in an axial direction, a tip being fixed to a front end of each tip holder, the shaft cylinder having an opening at a front end thereof, through which a tip fixed to one tip holder among the plurality of tip holders is projectable and retractable in conjunction with a movement of the one tip holder, the shaft cylinder comprising, an annular member capable of being loosely fitted on an outer periphery of one tip holder among the plurality of tip holders or one tip fixed to the one tip holder in conjunction with a movement of the one tip holder toward a front end side thereof to be movable in an axial direction of the one tip holder or the one tip with respect to the one tip holder or the one tip while being loosely fitted, an annular collar connected to the annular member via an elastic member, the annular collar being capable of coming into contact with the one tip holder in conjunction with the movement of the one tip holder toward the front end side, and a second elastic member configured to support the annular collar on an inside surface of the shaft cylinder, wherein a contact surface is formed on at least a part of an outer periphery of the annular member, the contact surface being configured to come into contact with a part of an inside surface of the shaft cylinder when the annular member is moved toward the front end side via the annular collar and the elastic member in conjunction with the movement of the one tip holder toward the front end side, a cutout is formed at a part of the annular member such that an inner diameter of the annular member is reduced when a load is received by the contact surface, a guide surface is formed on the part of the inside surface of the shaft cylinder, the guide surface being configured to come into contact with the contact surface in conjunction with the movement of the one tip holder toward the front end side, and the contact surface is configured to receive the load from the guide surface when the annular member is moved toward the front end side via the annular collar and the elastic member in conjunction with the movement of the one tip holder toward the front end side.

### Advantageous Effects of Invention

According to the first invention, the contact surface of the annular member receives the load from the guide surface of the shaft cylinder in conjunction with the movement of the tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the tip holder and the annular member are connected via the elastic member such that the tip holder and the annular member are movable relatively to each other, it can be assured that the tip or the tip holder can be effectively grasped in a rattling-free (play-free) manner even if no high-precision dimension management is applied to a degree of reduction of the inner diameter of the annular member or the like.

According to the second invention, the contact surface of the annular member receives the load from the guide surface of the shaft cylinder in conjunction with the movement of the tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the tip holder and the annular member are connected via the elastic member such that the tip holder and the annular member are movable relatively to each other, it can be assured that the tip or the tip holder can be effectively grasped in a rattling-free (play-free) manner even if no high-precision dimension management is applied to a degree of reduction of the inner diameter of the annular member or the like.

According to the third invention, the contact surface of the annular member receives the load from the guide surface of the shaft cylinder when the annular member is moved toward the front end side via the annular collar and the elastic member in conjunction with the movement of the one tip holder toward the front end side, which reduces the inner diameter of the annular member due to existence of the cutout of the annular member. In this manner, the shaft cylinder and the annular member cooperate with each other such that the tip or the tip holder can be grasped in a rattling-free (play-free) manner. In addition, since the annular collar abutted by the tip holder and the annular member are connected via the elastic member, it can be assured that the tip or the tip holder can be effectively grasped in a rattling-free (play-free) manner even if no high-precision dimension management is applied to a degree of reduction of the inner diameter of the annular member or the like.

### BRIEF DESCRIPTION OF DRAWINGS

FIG. 1 is a schematic longitudinal section view showing a projectable and retractable writing tool according to a first embodiment of a first invention, under a state wherein a tip (writing element) is not projected;

FIG. 2A is an enlarged longitudinal section view of a leading edge portion of the projectable and retractable writing tool shown in FIG. 1;

FIG. 2B is a section view taken along line A-A of FIG. 2A;

FIG. 3A is an enlarged longitudinal section view of the leading edge portion of the projectable and retractable writing tool shown in FIG. 1, under a state wherein the tip (writing element) is projected;

FIG. 3B is a section view taken along line B-B of FIG. 2A;

FIG. 4A is a perspective view of an annular member of the projectable and retractable writing tool shown in FIG. 1;

FIG. 4B is a side view of the annular member shown in FIG. 4A;

FIG. 4C is a section view taken along line C-C of FIG. 4B;

FIG. 4D is a front view (a view seen from the leading edge side) of the annular member shown in FIG. 4A;

FIG. 4E is a rear view of the annular member shown in FIG. 4A;

FIG. 5 is a schematic view showing the projectable and retractable writing tool shown in FIG. 1, under a state wherein the tip holder has been removed for replacement or the like;

FIG. 6 is a schematic longitudinal section view showing a projectable and retractable writing tool according to a second embodiment of the first invention, under a state wherein a tip (writing element) is not projected;

FIG. 7 is an enlarged longitudinal section view of a leading edge portion of the projectable and retractable writing tool shown in FIG. 6;

FIG. 8 is an enlarged longitudinal section view of the leading edge portion of the projectable and retractable writing tool shown in FIG. 6, under a state wherein the tip (writing element) is projected;

FIG. 9A is a perspective view of an annular member of the projectable and retractable writing tool shown in FIG. 6;

FIG. 9B is a side view of the annular member shown in FIG. 9A;

FIG. 9C is a section view taken along line C-C of FIG. 9B;

FIG. 9D is a front view (a view seen from the leading edge side) of the annular member shown in FIG. 9A;

FIG. 9E is a rear view of the annular member shown in FIG. 9A;

FIG. 9F is a section view taken along line F-F of FIG. 9B;

FIG. 9G is a section view taken along line G-G of FIG. 96;

FIG. 9H is an enlarged view of an H portion of FIG. 9C;

FIG. 10 is a schematic view showing the projectable and retractable writing tool shown in FIG. 6, under a state wherein the tip holder has been removed for replacement or the like;

FIG. 11 is a schematic longitudinal section view showing a projectable and retractable writing tool according to a third embodiment of the first invention, under a state wherein a tip (writing element) is not projected;

FIG. 12 is an enlarged longitudinal section view of a leading edge portion of the projectable and retractable writing tool shown in FIG. 11;

FIG. 13 is an enlarged longitudinal section view of the leading edge portion of the projectable and retractable writing tool shown in FIG. 11, under a state wherein the tip (writing element) is projected;

FIG. 14A is a perspective view of an annular member, a coil spring and a collar member of the projectable and retractable writing tool shown in FIG. 11;

FIG. 14B is a side view of the annular member, the coil spring and the collar member shown in FIG. 14A;

FIG. 14C is a front view (a view seen from the leading edge side) of the annular member, the coil spring and the collar member shown in FIG. 14A;

FIG. 14D is a rear view of the annular member, the coil spring and the collar member shown in FIG. 14A;

FIG. 15 is a schematic view showing the projectable and retractable writing tool shown in FIG. 11, under a state wherein the tip holder has been removed for replacement or the like;

FIG. 16 is a schematic longitudinal section view showing a projectable and retractable writing tool according to a fourth embodiment of the first invention, under a state wherein a tip (writing element) is not projected;

FIG. 17 is an enlarged longitudinal section view of a leading edge portion of the projectable and retractable writing tool shown in FIG. 16;

FIG. 18 is an enlarged longitudinal section view of the leading edge portion of the projectable and retractable writing tool shown in FIG. 16, under a state wherein the tip (writing element) is projected;

FIG. 19A is a perspective view of an annular member of the projectable and retractable writing tool shown in FIG. 16;

FIG. 19B is a side view of the annular member shown in FIG. 19A;

FIG. 19C is a section view taken along line C-C of FIG. 19B;

FIG. 19D is a front view (a view seen from the leading edge side) of the annular member shown in FIG. 19A;

FIG. 19E is a rear view of the annular member shown in FIG. 19A;

FIG. 19F is an enlarged view of an F portion of FIG. 19C;

FIG. 20 is a schematic view showing the projectable and retractable writing tool shown in FIG. 16, under a state wherein the tip holder has been removed for replacement or the like;

FIG. 21 is a schematic longitudinal section view showing a multi-tip writing tool according to an embodiment of a second invention, under a state wherein all tips (writing elements) are not projected;

FIG. 22 is an enlarged longitudinal section view of a leading edge portion of the multi-tip writing tool shown in FIG. 21;

FIG. 23 is a section view taken along line B-B of FIG. 22;

FIG. 24A is a side view of a tip, a tip holder, an annular member and an elastic member of the multi-tip writing tool shown in FIG. 21;

FIG. 24B is a section view taken along line A-A of FIG. 24A;

FIG. 25A is a perspective view of the tip holder, the annular member and the elastic member of the multi-tip writing tool shown in FIG. 21;

FIG. 25B is a longitudinal section view of the tip holder, the annular member and the elastic member shown in Fig, 25A;

FIG. 26 is a schematic longitudinal section view showing the multi-tip writing tool shown in FIG. 21, under a state wherein one tip (writing element) is projected;

FIG. 27 is an enlarged longitudinal section view of a leading edge portion of the multi-tip writing tool shown in FIG. 26;

FIG. 28 is a section view taken along line C-C of FIG. 27;

FIG. 29 is a schematic longitudinal section view showing a multi-tip writing tool according to an embodiment of a third invention, under a state wherein all tips (writing elements) are not projected;

FIG. 30 is an enlarged longitudinal section view of a leading edge portion of the multi-tip writing tool shown in FIG. 29;

FIG. 31 is a section view taken along line A-A of FIG. 30;

FIG. 32A is a perspective view of an annular member, an elastic member and a collar member of the multi-tip writing tool shown in FIG. 29;

FIG. 32B is a side view of the annular member, the elastic member and the collar member shown in FIG. 32A;

FIG. 32C is a section view taken along line C-C of FIG. 32B;

FIG. 32D is a front view (a view seen from the leading edge side) of the annular member, the elastic member and the collar member shown in FIG. 32A;

FIG. 32E is a rear view of the annular member, the elastic member and the collar member shown in FIG. 32A;

FIG. 33 is a schematic longitudinal section view showing the multi-tip writing tool shown in FIG. 29, under a state wherein one tip (writing element) is projected;

FIG. 34 is an enlarged longitudinal section view of a leading edge portion of the multi-tip writing tool shown in FIG. 33; and

FIG. 35 is a section view taken along line B-B of FIG. 34.

### DESCRIPTION OF EMBODIMENTS

With reference to the attached drawings, we explain four embodiments for the first invention, an embodiment for the second invention and an embodiment for the third invention.

### First Embodiment of First Invention

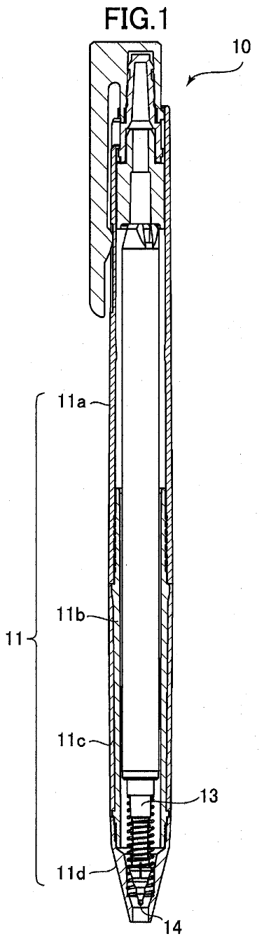

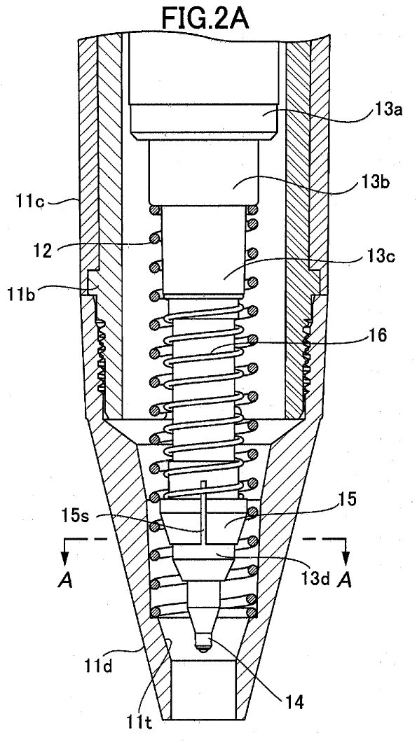

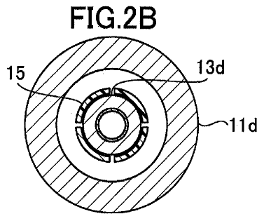

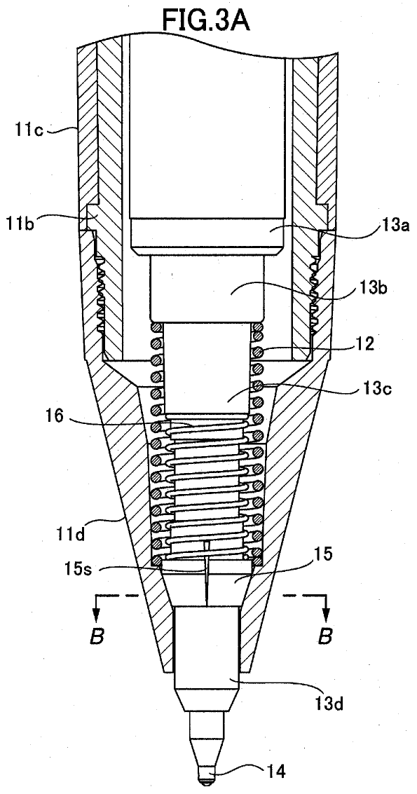

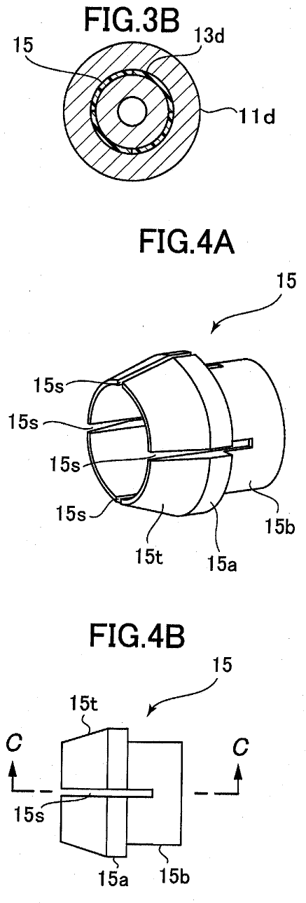

FIG. 1 is a schematic longitudinal section view showing a projectable and retractable writing tool 10 according to a first embodiment of the first invention under a state wherein a tip 14 (writing element) is not projected. FIG. 2A is an enlarged longitudinal section view of a leading edge portion of the projectable and retractable writing tool 10 according to the present embodiment, and FIG. 2B is a section view taken along line A-A of FIG. 2A. FIG. 3A is an enlarged longitudinal section view of the leading edge portion of the projectable and retractable writing tool 10 according to the present embodiment, under a state wherein the tip 14 (writing element) is projected, and FIG. 3B is a section view taken along line B-B of FIG. 2A.

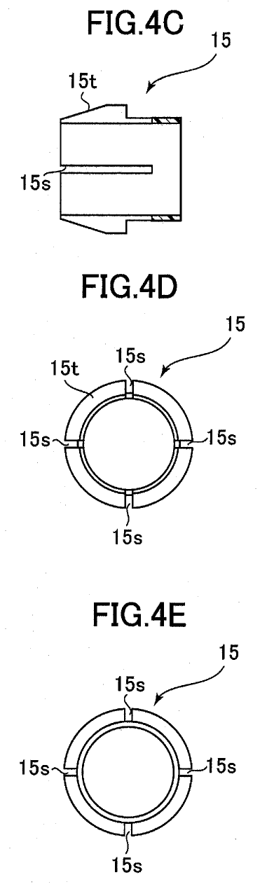

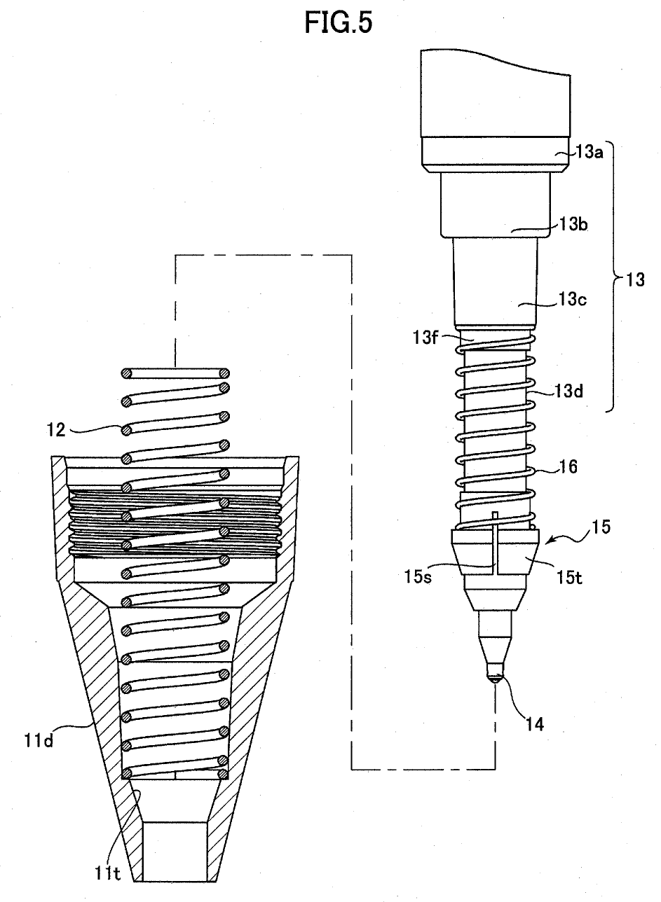

In addition, FIG. 4A is a perspective view of an annular member 15 of the projectable and retractable writing tool 10 according to the present embodiment, FIG. 4B is a side view of the annular member 15, FIG. 4C is a section view taken along line C-C of FIG. 4B, FIG. 4D is a front view (a view seen from the leading edge side) of the annular member 15, and FIG. 4E is a rear view of the annular member 15.

In addition, FIG. 5 is a schematic view showing the projectable and retractable writing tool 10 according to the present invention, under a state wherein the tip holder 13 has been removed for replacement or the like.

The projectable and retractable writing tool 10 according to the first embodiment shown in FIGS. 1 to 5 includes a shaft cylinder 11, which has an opening at a front end thereof and has a cylindrical shape. As shown in FIGS. 1 to 3, according to the present embodiment, the shaft cylinder 11 has a rear portion 11a, an inner cylindrical portion 11b, a front portion 11c and a mouthpiece portion 11d. The rear portion 11a and the inner cylindrical portion 11b are threadedly removably fixed to each other. The inner cylindrical portion 11b and the front portion 11c are integrally formed by two-color molding. Of course, the rear portion 11a and the inner cylindrical portion 11b may be fixed to each other by fitting connection or may be formed integrally. The inner cylindrical portion 11b and the front portion 11c may also be fixed by fitting connection. On the other hand, the mouthpiece portion 11d is threadedly detachably fixed to the inner cylindrical portion 11b. The material of the mouthpiece portion 11d is not limited to metal, but may be resin.

A tip holder 13, which is movable in an axial direction of the shaft cylinder 11, is contained in an inside of the shaft cylinder 11. A tip 14 as a writing element is fixed to a front end of the tip holder 13. The tip 14 is projectable and retractable through the opening of the shaft cylinder 11 in conjunction with a movement of the tip holder 13, as shown in FIGS. 2 and 3.

As shown in FIG. 5, the tip holder 13 includes: a proximal portion 13a, a first collar portion 13b, a second collar portion 13c, a spring fixation assisting portion 13f and a distal portion 13d, in this order from a proximal side thereof toward a distal side thereof. In the present embodiment, each of the proximal portion 13a, the first collar portion 13b, the second collar portion 13c, the spring fixation assisting portion 13f and the distal portion 13d has a cylindrical shape. The relationship between their cross-sectional diameters is as follows: the proximal portion 13a>the first collar portion 13b>the second collar portion 13c>the spring fixation assisting portion 13f>the distal portion 13d.

In the present embodiment, in particular as shown in FIG. 2B, an annular member 15 made of resin (for example, polyacetal) or metal (for example, brass) is loosely fitted on an outer periphery of the distal portion 13d of the tip holder 13. The annular member 15 is fixed to a second collar portion 13c of the tip holder 13 via a coil spring 16 (an example of an elastic member), which surrounds the outer periphery of the distal portion 13d of the tip holder 13 in a loosely fitted state (with a slight gap). In this manner, as shown in FIGS. 2A and 3A, the annular member 15 is movable in an axial direction of the tip holder 13 with respect to the distal portion 13d of the tip holder 13, in conjunction with expansion and contraction of the coil spring 16.

The tip holder 13 of the present embodiment is provided with the spring fixation assisting portion 13f in order to assist in fixing the coil spring 16 to the second collar portion 13c.

In addition, in particular as shown in FIGS. 4A to 4E, a frustoconical contact surface 15t is formed on a front region of an outer periphery of the annular member 15, as a contact surface having a tapered shape toward the front end side. A large outer diameter cylindrical portion 15a is provided continuously on a rear side of the contact surface 15t. A small outer diameter cylindrical portion 15b is provided on a further rear side thereof via a step (diameter difference).

The annular member 15 of the present embodiment is provided with four slits (cutout elements) 15s as a cutout. As shown in FIGS. 4A to 4E, the four slits 15s are arranged at regular intervals (by every 90 degrees) in a circumferential direction of the annular member 15. Each of the four slits 15s extends from a front end of the annular member 15 to a substantially center of the small outer diameter cylindrical portion 15b in an axial direction of the annular member 15. Thus, when a load is received by the contact surface 15t, an inner diameter of the annular member 15 is configured to be reduced flexibly, and when the load is released, the inner diameter of the annular member 15 is configured to be elastically returned to an original dimension thereof.

In addition, as shown in FIGS. 2A and 3A, a concave frustoconical guide surface 11t is formed on a part of an inside surface of the mouthpiece portion 11d of the shaft cylinder 11, as a guide surface having a tapered shape toward the front end side. Thus, in conjunction with a movement of the tip holder 13 toward a front end side thereof (FIG. 2A→FIG. 3A), the contact surface 15t is configured to receive the load from the guide surface 11t.

Furthermore, the projectable and retractable writing tool 10 according to the present embodiment is provided with a second coil spring 12 (second elastic member) in order to automatically retract the tip holder 13 when a retracting operation for the tip 14 (for example, a pushing operation of a push button provided on a rear end portion of the writing tool in order to release a locking mechanism that can maintain a projected state of the tip 14) is carried out. The second coil spring 12 is fitted into between a shoulder portion provided on the inside surface of the mouthpiece portion 11d and the first collar 13b of the tip holder 13 such that the second coil spring 12 surrounds an outer periphery of the coil spring 16.

The second coil spring 12 may be fixed to the inside surface of the mouthpiece portion 11d or may be free (in a state wherein neither member is fixed thereto). Alternatively, the second coil spring 12 may be fixed to the first collar 13b of the tip holder 13.

The projectable and retractable writing tool 10 as described above operates as follows.

When not in use, the tip 14 (writing element) of the projectable and retractable writing tool 10 is retracted as shown in FIG. 2A. A length of the coil spring 16 in an axial direction thereof is 8.2 mm and a length of the second coil spring 12 in an axial direction thereof is 16.4 mm. When a projecting operation for the tip 14 (for example, a pushing operation of a push button provided on the rear end portion of the writing tool) is carried out, the tip 14 (writing element) of the projectable and retractable writing tool 10 is projected as shown in FIG. 3A, Usually, a position of the tip holder 13 is locked in this projected state. The projected state of the tip 14 is maintained until a retracting operation for the tip 14 is carried out thereafter. The length of the coil spring 16 in the axial direction thereof is 5.6 mm (shortened by 2.6 mm) and the length of the second coil spring 12 in the axial direction thereof is 9.4 mm (shortened by 7.0 mm).

During a transition from the retracted state shown in FIG. 2A to the projected state shown in FIG. 3A, in conjunction with the movement of the tip holder 13 toward the front end side, the contact surface 15t of the annular member 15 receives a load from the guide surface 11t of the mouthpiece portion 11d. At this time, the inner diameter of the annular member 15 is reduced due to existence of the four slits 15s of the annular member 15 (FIG. 2B→FIG. 3B). As a result, as shown in FIG. 3B, the mouthpiece portion 11d and the annular member 15 cooperate with each other such that the distal portion 13d of the tip holder 13 can be grasped in a rattling-free (play-free) manner

In addition, since the tip holder 13 and the annular member 15 are connected via the coil spring 16 such that the tip holder 13 and the annular member 15 are movable relatively to each other, it can be assured that the distal portion 13d of the tip holder 13 can be effectively grasped in a rattling-free (play-free) manner even if no high-precision dimension management is applied to a degree of reduction of the inner diameter of the annular member 15 or the like.

Thereafter, when a retracting operation for the tip 14 (for example, a subsequent pushing operation of the push button provided on the rear end portion of the writing tool) is carried out, a locking mechanism not shown is released, so that the tip 14 (writing element) of the projectable and retractable writing tool 10 is returned to a retracted state shown in FIG. 2A by means of an action of the second coil spring 12.

During a transition from the projected state shown in FIG. 3A to the retracted state shown in FIG. 2A, in conjunction with a movement of the tip holder 13 toward a rear end side, the load received by the contact surface 15t of the annular member 15 from the guide surface 11t of the mouthpiece portion 11d disappears. Thereby, the inner diameter of the annular member 15 that has been reduced is returned to an original dimension thereof (FIG. 3B→FIG. 2B).

As described above, according to the projectable and retractable writing tool 10 of the present embodiment, when the contact surface 15t of the annular member 15 receives the load from the guide surface 11t of the mouthpiece portion 11d in conjunction with the movement of the tip holder 13 toward the front end side, the inner diameter of the annular member 15 is reduced due to the existence of the slits 15s of the annular member 15. In this manner, the base potion 11d and the annular member 15 cooperate with each other such that the distal portion 13d of the tip holder 13 can be grasped in a rattling-free (play-free) manner. In addition, since the tip holder 13 and the annular member 15 are connected via the elastic member 16 such that the tip holder 13 and the annular member 15 are movable relatively to each other, it can be assured that the distal portion 13d of the tip holder 13 can be effectively grasped in a rattling-free (play-free) manner even if no high-precision dimension management is applied to a degree of reduction of the inner diameter of the annular member 15 or the like.

In addition, according to the projectable and retractable writing tool 10 of the present embodiment, since the four slits 15s as a cutout are arranged at regular intervals in a circumferential direction of the annular member 15 and each slit 15s extends in the axial direction of the annular member 15, the inner diameter of the annular member 15 can be reduced in a circumferentially well-balanced manner.

In addition, the contact surface 15t and the guide surface 11t have the frustoconical shape and the concave frustoconical shape which correspond to each other. Thus, the contact surface 15t of the annular member 15 can receive the load in a circumferentially well-balanced manner, so that the inner diameter of the annular member 15 can be reduced in a circumferentially well-balanced manner. Like this, it is preferable that the contact surface 15t and the guide surface 11t have tapered shapes toward the front end side. A tapered contact surface 15t may be formed by providing a rounded portion at an outer periphery of the front end of the cylindrical annular member 15. In addition, a tapered contact surface 15t may have a convex curved surface which is rotationally symmetric about an axis, and a tapered guide surface 11t may have a concave curved surface or a concave frustoconical surface which is also rotationally symmetric about the axis but has a curvature gentler than that of the convex curved surface.

In addition, in the projectable and retractable writing tool 10 of the present embodiment, the annular member 15 is movable in the axial direction in a region of the distal portion 13d of the tip holder 13, and the annular member 15 is configured to grasp the region of the distal portion 13d of the tip holder 13 when the inner diameter of the annular member 15 is reduced. However, the present invention is not limited thereto. For example, the annular member 15 may be movable in the axial direction in a region of the tip 14, and the annular member 15 may be configured to grasp the region of the tip 14 when the inner diameter of the annular member 15 is reduced.

In addition, it is possible to adjust elasticity (easiness of reduction of the inner diameter) of the annular member 15 by suitably changing the number of the slits 15s, the sizes of the slits 15s and/or the shapes of the slits 15s. In addition, it is also possible to adjust elasticity (easiness of reduction of the inner diameter) of the annular member 15 by changing a material and/or a thickness of the annular member 15.

### Second Embodiment of First Invention

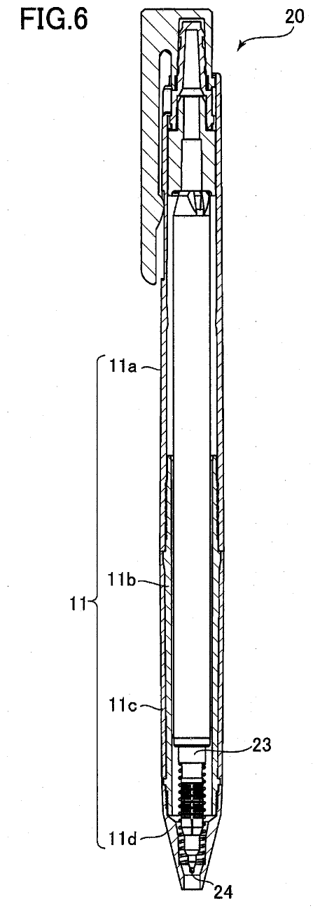

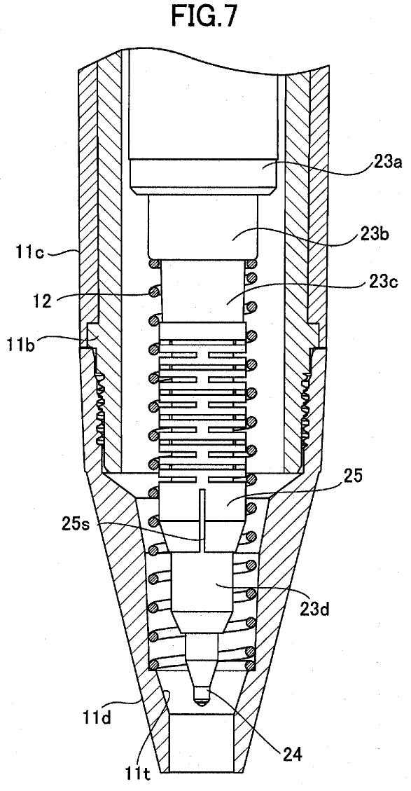

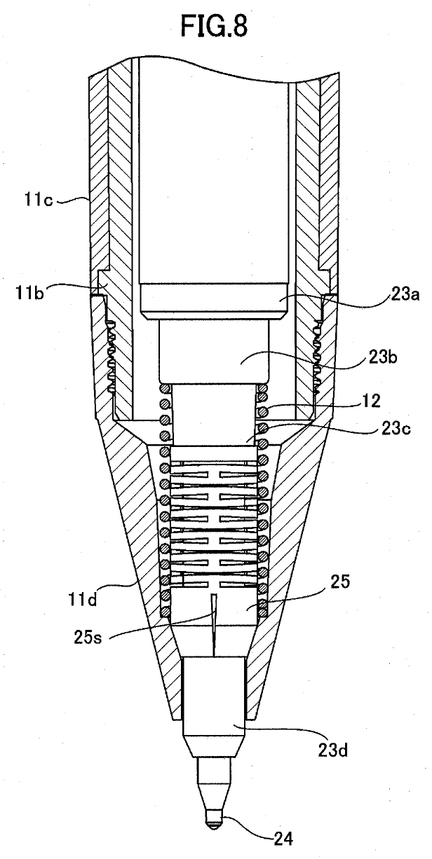

FIG. 6 is a schematic longitudinal section view showing a projectable and retractable writing tool 20 according to a second embodiment of the first invention under a state wherein a tip 24 (writing element) is not projected. FIG. 7 is an enlarged longitudinal section view of a leading edge portion of the projectable and retractable writing tool 20 according to the present embodiment. FIG. 8 is an enlarged longitudinal section view of the leading edge portion of the projectable and retractable writing tool 20 according to the present embodiment, under a state wherein the tip 24 (writing element) is projected.

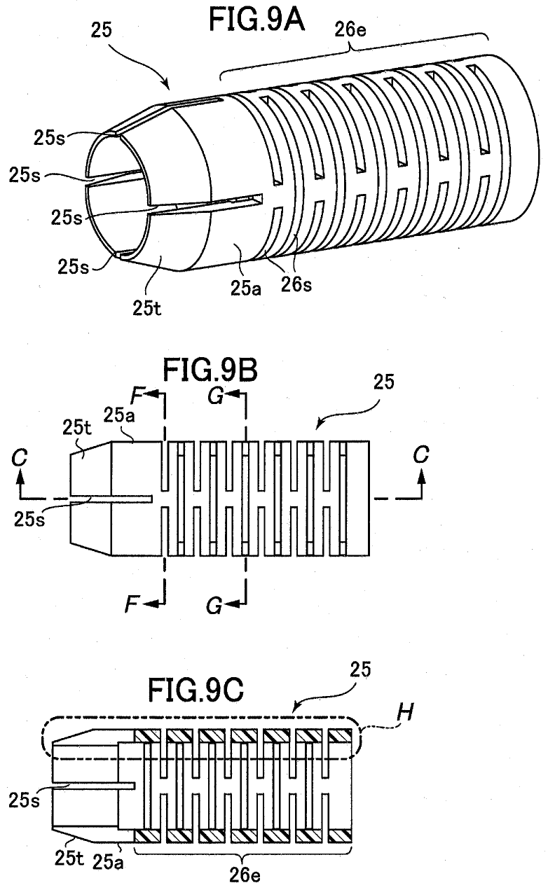

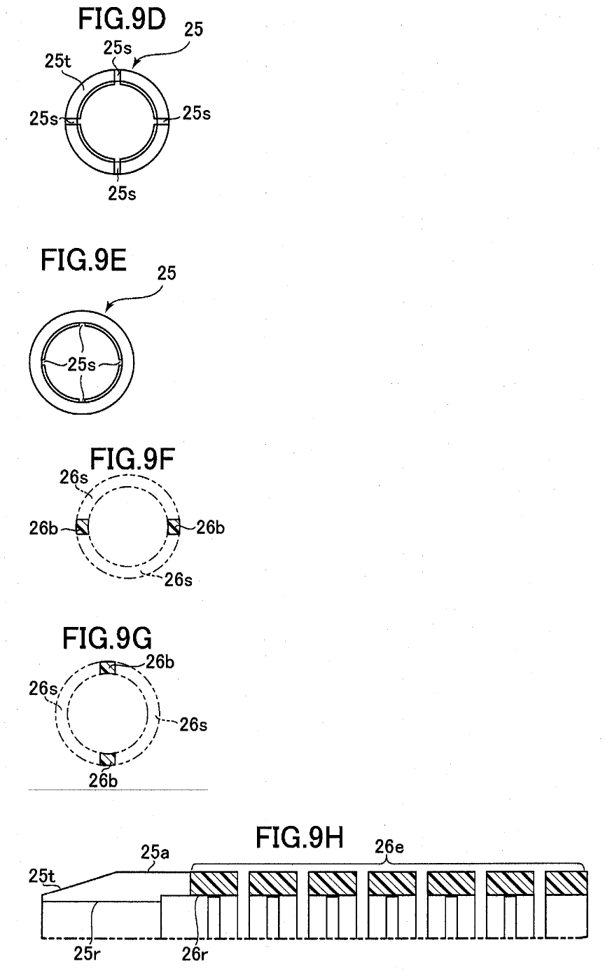

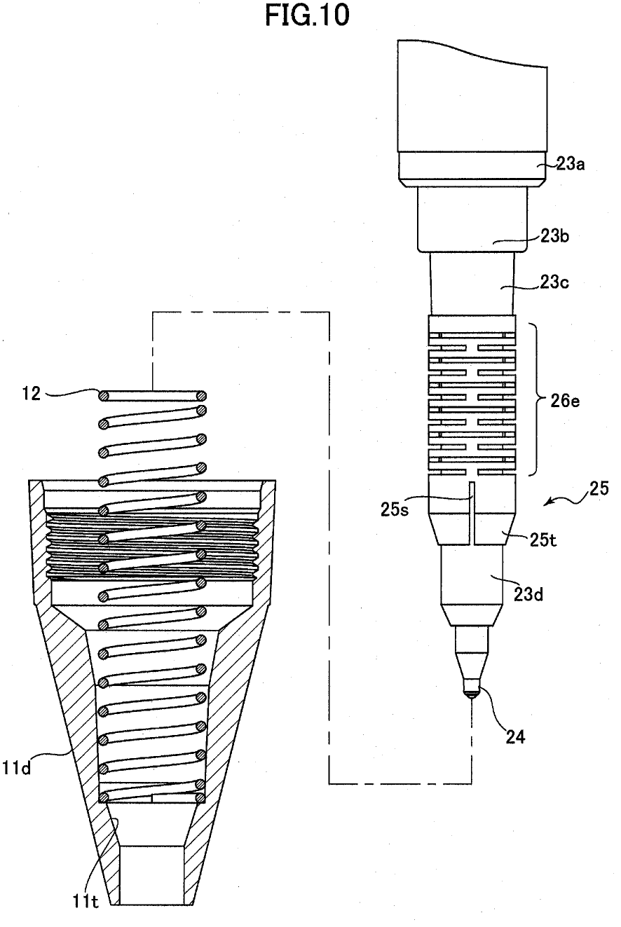

In addition, FIG. 9A is a perspective view of an annular member 25 of the projectable and retractable writing tool 20 according to the present embodiment, FIG. 9B is a side view of the annular member 25, FIG. 9C is a section view taken along line C-C of FIG. 9B, FIG. 9D is a front view (a view seen from the leading edge side) of the annular member 25, and FIG. 9E is a rear view of the annular member 25. In addition, FIG. 9F is a section view taken along line F-F of FIG. 9B, FIG. 9G is a section view taken along line G-G of FIG. 9B, and FIG. 9H is an enlarged view of an H portion of FIG. 9C.

In addition, FIG. 10 is a schematic view showing the projectable and retractable writing tool 20 according to the present invention, under a state wherein the tip holder 23 has been removed for replacement or the like.

As well as the first embodiment, the projectable and retractable writing tool 20 according to the second embodiment shown in FIGS. 6 to 10 includes a shaft cylinder 11, which has an opening at a front end thereof and has a cylindrical shape. As shown in FIGS. 6 to 8, according to the present embodiment as well, the shaft cylinder 11 has a rear portion 11a, an inner cylindrical portion 11b, a front portion 11c and a mouthpiece portion 11d. The rear portion 11a and the inner cylindrical portion 11b are threadedly removably fixed to each other. The inner cylindrical portion 11b and the front portion 11c are integrally formed by two-color molding. Of course, the rear portion 11a and the inner cylindrical portion 11b may be fixed to each other by fitting connection or may be formed integrally. The inner cylindrical portion 11b and the front portion 11c may also be fixed by fitting connection. On the other hand, the mouthpiece portion 11d is threadedly detachably fixed to the inner cylindrical portion 11b. The material of the mouthpiece portion lid is not limited to metal, but may be resin.

A tip holder 23, which is movable in an axial direction of the shaft cylinder 11, is contained in an inside of the shaft cylinder 11. A tip 24 as a writing element is fixed to a front end of the tip holder 23. The tip 24 is projectable and retractable through the opening of the shaft cylinder 11 in conjunction with a movement of the tip holder 23, as shown in FIGS. 7 and 8.

As shown in FIG. 10, the tip holder 23 includes: a proximal portion 23a, a first collar portion 23b, a second collar portion 23c and a distal portion 23d, in this order from a proximal side thereof toward a distal side thereof. In the present embodiment, each of the proximal portion 23a, the first collar portion 23b, the second collar portion 23c and the distal portion 23d has a cylindrical shape. The relationship between their cross-sectional diameters is as follows: the proximal portion 23a>the first collar portion 23b>the second collar portion 23c>the distal portion 23d.

In the present embodiment, in particular as shown in FIG. 7, an annular member 25 made of resin (for example, polyacetal) is loosely fitted on an outer periphery of the distal portion 23d of the tip holder 23. The annular member 25 of the present embodiment is integrally molded with a tubular resin spring part 26e on a proximal end side thereof. A large number of slits 26s, each of which extends in a direction perpendicular to an axial direction, are formed in the resin spring part 26e, so that the resin spring part 26e can extend and contract in the axial direction.

As shown in FIGS. 9A to 9H, in the resin spring part 26e of the present embodiment, six pairs of substantially semicircular slits 26s facing up and down (see FIG. 9F) and six pairs of substantially semicircular slits 26s facing left and right (see FIG. 9G) are formed alternately in the axial direction. The remaining portion between the pairs of slits 26s is called a rib 26b. In the present embodiment, the width (the length in the axial direction) of each slit 26s is uniform, the axial gap between the slits 26s adjacent in the axial direction is also uniform, and the former is slightly smaller than the latter. Of course, these dimensional relationship may be suitably adjusted to achieve a desired degree of elasticity, as described below.

A further proximal end side of the resin spring part 26e is fixed to a second collar portion 23c of the tip holder 23. In this manner, as shown in FIGS. 7 and 8, the annular member 25 is movable in an axial direction of the tip holder 23 with respect to the distal portion 23d of the tip holder 23, in conjunction with expansion and contraction of the resin spring part 26e.

In addition, in particular as shown in FIGS. 9A to 9E, a frustoconical contact surface 25t is formed on a front region of an outer periphery of the annular member 25, as a contact surface having a tapered shape toward the front end side. A cylindrical portion 25a is provided continuously on a rear side of the contact surface 25t. The tubular resin spring part 26e, whose diameter is the same as that of the cylindrical portion 25a, is provided on a further rear side thereof. In addition, in particular as shown in FIG. 9H, an inner diameter 26r of the resin spring part 26e is larger than an inner diameter 25r of a portion corresponding to the contact surface 25t.

The annular member 25 of the present embodiment is provided with four slits (cutout elements) 25s as a cutout. As shown in FIGS. 9A to 9E, the four slits 25s are arranged at regular intervals (by every 90 degrees) in a circumferential direction of the annular member 25. Each of the four slits 25s extends from a front end of the annular member 25 to a vicinity of a rear end of the cylindrical portion 25a in an axial direction of the annular member 25. Thus, when a load is received by the contact surface 25t, an inner diameter of the annular member 25 is configured to be reduced flexibly, and when the load is released, the inner diameter of the annular member 25 is configured to be elastically returned to an original dimension thereof.

In addition, as shown in FIGS. 7 and 8, a concave frustoconical guide surface 11t is formed on a part of an inside surface of the mouthpiece portion lid of the shaft cylinder 11, as a guide surface having a tapered shape toward the front end side. Thus, in conjunction with a movement of the tip holder 23 toward a front end side thereof (FIG. 7→FIG. 8), the contact surface 25t is configured to receive the load from the guide surface 11t.

Furthermore, the projectable and retractable writing tool 20 according to the present embodiment is also provided with a second coil spring 12 (second elastic member) in order to automatically retract the tip holder 23 when a retracting operation for the tip 24 (for example, a pushing operation of a push button provided on a rear end portion of the writing tool in order to release a locking mechanism that can maintain a projected state of the tip 24) is carried out. The second coil spring 12 is fitted into between a shoulder portion provided on the inside surface of the mouthpiece portion 11d and the first collar portion 23b of the tip holder 23 such that the second coil spring 12 surrounds an outer periphery of the annular member 25.

The second coil spring 12 may be fixed to the inside surface of the mouthpiece portion 11d or may be free (in a state wherein neither member is fixed thereto). Alternatively, the second coil spring 12 may be fixed to the first collar portion 23b of the tip holder 23.

The projectable and retractable writing tool 20 as described above operates as follows.

When not in use, the tip 24 (writing element) of the projectable and retractable writing tool 20 is retracted as shown in FIG. 7. A length of the annular member 25 including the resin spring part 26e in an axial direction thereof is 9.2 mm and a length of the second coil spring 12 in an axial direction thereof is 16.4 mm. When a projecting operation for the tip 24 (for example, a pushing operation of a push button provided on the rear end portion of the writing tool) is carried out, the tip 24 (writing element) of the projectable and retractable writing tool 20 is projected as shown in FIG. 8. Usually, a position of the tip holder 23 is locked in this projected state. The projected state of the tip 24 is maintained until a retracting operation for the tip 24 is carried out thereafter. The length of the annular member 25 including the resin spring part 26e in the axial direction thereof is 8.5 mm (shortened by 0.7 mm) and the length of the second coil spring 12 in the axial direction thereof is 9.4 mm (shortened by 7.0 mm).

During a transition from the retracted state shown in FIG. 7 to the projected state shown in FIG. 8, in conjunction with the movement of the tip holder 23 toward the front end side, the contact surface 25t of the annular member 25 receives a load from the guide surface 11t of the mouthpiece portion 11d. At this time, the inner diameter of the annular member 25 is reduced due to existence of the four slits 25s of the annular member 25 (see FIG. 3B). As a result, as shown in FIG. 8, the mouthpiece portion 11d and the annular member 25 cooperate with each other such that the distal portion 23d of the tip holder 23 can be grasped in a rattling-free (play-free) manner.

In addition, since the tip holder 23 and the contact surface 25t of the annular member 25 are movable relatively to each other by means of expansion and contraction of the resin spring part 26e, it can be assured that the distal portion 23d of the tip holder 23 can be effectively grasped in a rattling-free (play-free) manner even if no high-precision dimension management is applied to a degree of reduction of the inner diameter of the annular member 25 or the like.

Thereafter, when a retracting operation for the tip 24 (for example, a subsequent pushing operation of the push button provided on the rear end portion of the writing tool) is carried out, a locking mechanism not shown is released, so that the tip 24 (writing element) of the projectable and retractable writing tool 20 is returned to a retracted state shown in FIG. 7 by means of an action of the second coil spring 12.

During a transition from the projected state shown in FIG. 8 to the retracted state shown in FIG. 7, in conjunction with a movement of the tip holder 23 toward a rear end side, the load received by the contact surface 25t of the annular member 25 from the guide surface 11t of the mouthpiece portion 11d disappears. Thereby, the inner diameter of the annular member 25 that has been reduced is returned to an original dimension thereof (FIG. 8→FIG. 7).

As described above, according to the projectable and retractable writing tool 20 of the present embodiment, when the contact surface 25t of the annular member 25 receives the load from the guide surface 11t of the mouthpiece portion 11d in conjunction with the movement of the tip holder 23 toward the front end side, the inner diameter of the annular member 25 is reduced due to the existence of the slits 25s of the annular member 25. In this manner, the base potion 11d and the annular member 25 cooperate with each other such that the distal portion 23d of the tip holder 23 can be grasped in a rattling-free (play-free) manner. In addition, since the tip holder 23 and the contact surface 25t of the annular member 25 are connected via the resin spring part 26e such that the tip holder 23 and the contact surface 25t are movable relatively to each other, it can be assured that the distal portion 23d of the tip holder 23 can be effectively grasped in a rattling-free (play-free) manner even if no high-precision dimension management is applied to a degree of reduction of the inner diameter of the annular member 25 or the like.

In addition, since the inner diameter 26r of the resin spring part 26e is larger than the inner diameter 25r of the portion corresponding to the contact surface 25t, even if the resin spring part 26e swells toward an inner diameter side, the resin spring parte 26 does not come into contact with the tip holder 23.

In addition, according to the projectable and retractable writing tool 20 of the present embodiment, since the four slits 25s as a cutout are arranged at regular intervals in a circumferential direction of the annular member 25 and each slit 25s extends in the axial direction of the annular member 25, the inner diameter of the annular member 25 can be reduced in a circumferentially well-balanced manner.

In addition, the contact surface 25t and the guide surface 11t have the frustoconical shape and the concave frustoconical shape which correspond to each other. Thus, the contact surface 25t of the annular member 25 can receive the load in a circumferentially well-balanced manner, so that the inner diameter of the annular member 25 can be reduced in a circumferentially well-balanced manner. Like this, it is preferable that the contact surface 25t and the guide surface 11t have tapered shapes toward the front end side. A tapered contact surface 25t may be formed by providing a rounded portion at an outer periphery of the front end of the cylindrical annular member 25. In addition, a tapered contact surface 25t may have a convex curved surface which is rotationally symmetric about an axis, and a tapered guide surface 11t may have a concave curved surface or a concave frustoconical surface which is also rotationally symmetric about the axis but has a curvature gentler than that of the convex curved surface.

In addition, in the projectable and retractable writing tool 20 of the present embodiment, the annular member 25 is movable in the axial direction in a region of the distal portion 23d of the tip holder 23, and the annular member 25 is configured to grasp the region of the distal portion 23d of the tip holder 23 when the inner diameter of the annular member 25 is reduced. However, the present invention is not limited thereto. For example, the annular member 25 may be movable in the axial direction in a region of the tip 24, and the annular member 25 may be configured to grasp the region of the tip 24 when the inner diameter of the annular member 25 is reduced.

In addition, it is possible to adjust elasticity (easiness of reduction of the inner diameter) of the annular member 25 by suitably changing the number of the slits 25s, the sizes of the slits 25s and/or the shapes of the slits 25s. In addition, it is also possible to adjust elasticity (easiness of reduction of the inner diameter) of the annular member 25 by suitably changing a material and/or a thickness of the annular member 25.

In addition, it is possible to adjust elasticity (easiness of expansion and contraction) of the resin spring part 26e by suitably changing the number of the slits 26s, the sizes of the slits 26s and/or the shapes of the slits 26s. It is preferable that the slits 26s extend in the direction perpendicular to the axial direction. However, they may extend obliquely (for example, spirally) with respect to the axial direction.

In addition, it is also possible to adjust elasticity (easiness of expansion and contraction) of the resin spring part 2e6 by changing a thickness of the resin spring part 26e. Furthermore, the resin spring part 26e may be formed as a resin spring member separate from the contact surface 25t and the cylindrical portion 25a, and may be joined to the cylindrical portion 25a. In this case, it is also possible to adjust elasticity (easiness of expansion and contraction) of the resin spring member by changing a material of the resin spring member.

Furthermore, the resin spring part 26e (or a separate resin spring member) is not limited to the configuration having the slit 26s, but may be a configuration having a bellows structure that expands and contracts in the axial direction.

### Third Embodiment of First Invention

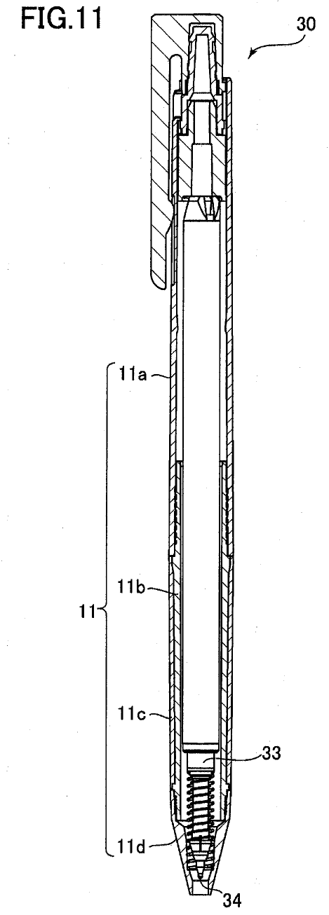

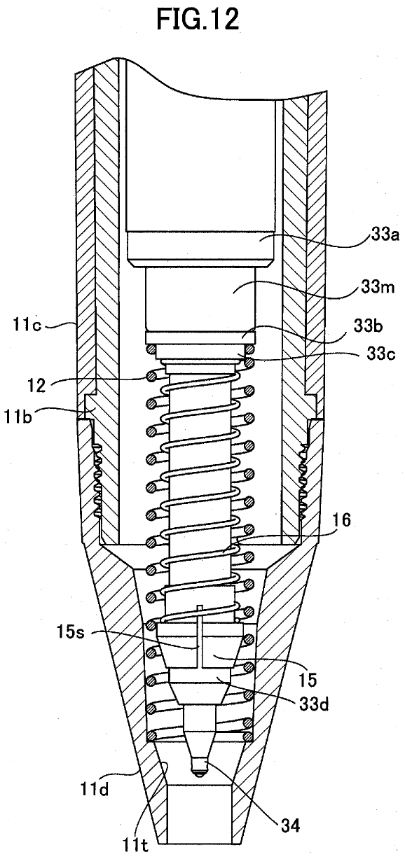

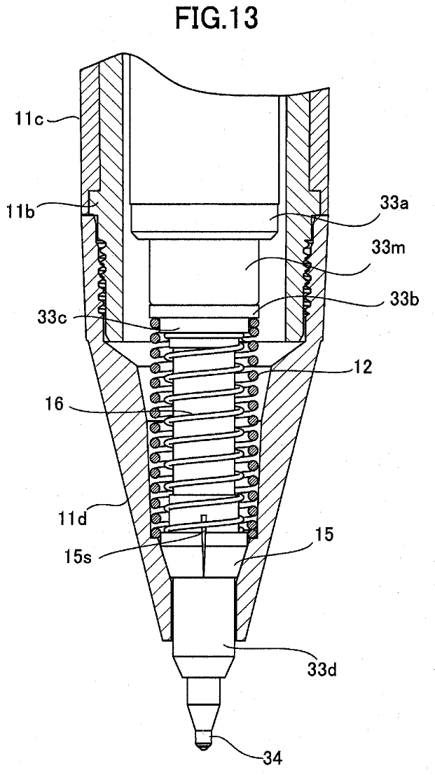

FIG. 11 is a schematic longitudinal section view showing a projectable and retractable writing tool 30 according to a third embodiment of the first invention under a state wherein a tip 34 (writing element) is not projected. FIG. 12 is an enlarged longitudinal section view of a leading edge portion of the projectable and retractable writing tool 30 according to the present embodiment. FIG. 13 is an enlarged longitudinal section view of the leading edge portion of the projectable and retractable writing tool 30 according to the present embodiment, under a state wherein the tip 34 (writing element) is projected.

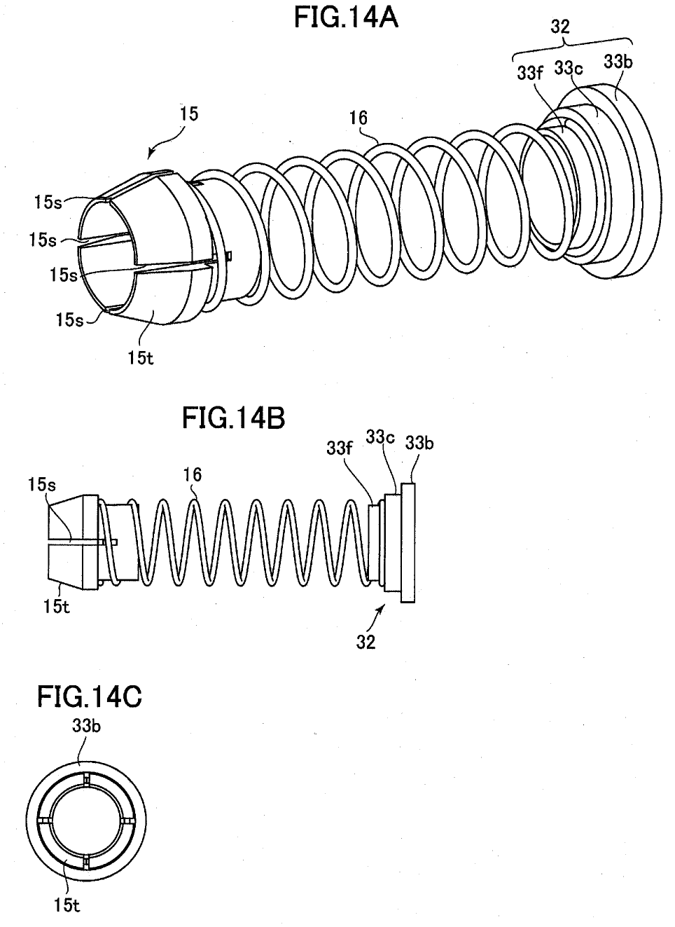

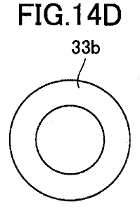

In addition, FIG. 14A is a perspective view of an annular member 15, a coil spring 16 and a collar member 32 of the projectable and retractable writing tool 30 according to the present embodiment, FIG. 14B is a side view of the annular member 15, the coil spring 16 and the collar member 32, FIG. 14C is a front view (a view seen from the leading edge side) of the annular member 15, the coil spring 16 and the collar member 32, and FIG. 14D is a rear view of the annular member 15, the coil spring 16 and the collar member 32.

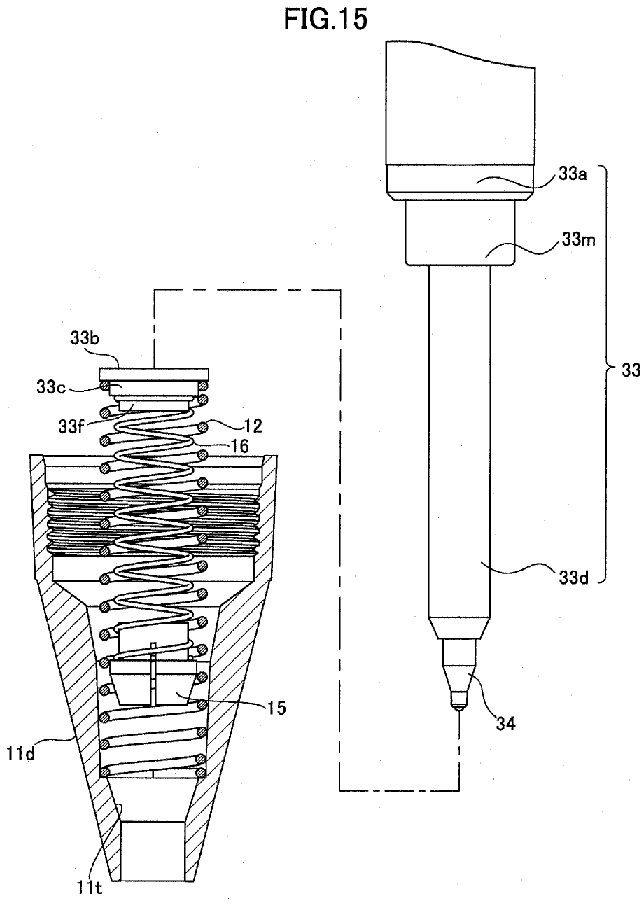

In addition, FIG. 15 is a schematic view showing the projectable and retractable writing tool 30 according to the present invention, under a state wherein the tip holder 33 has been removed for replacement or the like.

As well as the first and second embodiments, the projectable and retractable writing tool 30 according to the third embodiment shown in FIGS. 11 to 15 includes a shaft cylinder 11, which has an opening at a front end thereof and has a cylindrical shape. As shown in FIGS. 11 to 13, according to the present embodiment as well, the shaft cylinder 11 has a rear portion 11a, an inner cylindrical portion 11b, a front portion 11c and a mouthpiece portion 11d. The rear portion 11a and the inner cylindrical portion 11b are threadedly removably fixed to each other. The inner cylindrical portion 11b and the front portion 11c are integrally formed by two-color molding. Of course, the rear portion 11a and the inner cylindrical portion 11b may be fixed to each other by fitting connection or may be formed integrally. The inner cylindrical portion 11b and the front portion 11c may also be fixed by fitting connection. On the other hand, the mouthpiece portion 11d is threadedly detachably fixed to the inner cylindrical portion 11b. The material of the mouthpiece portion 11d is not limited to metal, but may be resin.

A tip holder 33, which is movable in an axial direction of the shaft cylinder 11, is contained in an inside of the shaft cylinder 11. A tip 34 as a writing element is fixed to a front end of the tip holder 33. The tip 34 is projectable and retractable through the opening of the shaft cylinder 11 in conjunction with a movement of the tip holder 33, as shown in FIGS. 12 and 13.

As shown in FIG. 15, the tip holder 33 includes: a proximal portion 33a, a middle collar portion 33m and a distal portion 33d, in this order from a proximal side thereof toward a distal side thereof. In the present embodiment, each of the proximal portion 33a, the middle collar portion 33m and the distal portion 33d has a cylindrical shape. The relationship between their cross-sectional diameters is as follows: the proximal portion 33a>the middle collar portion 33m>the distal portion 33d.

In the present embodiment, in particular as shown in FIG. 12, an annular member 15 made of resin (for example, polyacetal) or metal (for example, brass) is loosely fitted on an outer periphery of the distal portion 33d of the tip holder 33. The annular member 15 is fixed to a second collar portion 33c of the collar member 32 via the coil spring 16 (an example of an elastic member), which surrounds the outer periphery of the distal portion 33d of the tip holder 33 in a loosely fitted state (with a slight gap), as shown in FIGS. 14A and 14B. A first collar portion 33b of the collar member 32 is abutted and supported by the middle collar portion 33m of the tip holder 33 in the axial direction. In this manner, the annular member 15 is movable in an axial direction of the tip holder 33 with respect to the distal portion 33d of the tip holder 33, in conjunction with expansion and contraction of the coil spring 16.

The collar member 32 of the present embodiment is provided with a spring fixation assisting portion 33f in order to assist in fixing the coil spring 16 to the second collar portion 33c. That is to say, the collar member 32 has the first collar portion 33b, the second collar portion 33c and the spring fixation assisting portion 33f, in this order from a proximal side thereof toward a distal side thereof. In the present embodiment, each of the first collar portion 33b, the second collar portion 33c and the spring fixation assisting portion 33f has a cylindrical shape. The relationship between their cross-sectional diameters is as follows: the first collar portion 33b>the second collar portion 33c>the spring fixation assisting portion 33f.

The annular member 15 and the coil spring 16 of the present embodiment are respectively the same as the annular member 15 and the coil spring 16 of the first embodiment. Thus, the same reference numbers are used for the corresponding members.

That is to say, as shown in FIGS. 4A to 4E, a frustoconical contact surface 15t is formed on a front region of an outer periphery of the annular member 15, as a contact surface having a tapered shape toward the front end side. A large outer diameter cylindrical portion 15a is provided continuously on a rear side of the contact surface 15t. A small outer diameter cylindrical portion 15b is provided on a further rear side thereof via a step (diameter difference).

In addition, the annular member 15 is provided with four slits (cutout elements) 15s as a cutout. As shown in FIGS. 4A to 4E, the four slits 15s are arranged at regular intervals (by every 90 degrees) in a circumferential direction of the annular member 15. Each of the four slits 15s extends from a front end of the annular member 15 to a substantially center of the small outer diameter cylindrical portion 15b in an axial direction of the annular member 15. Thus, when a load is received by the contact surface 15t, an inner diameter of the annular member 15 is configured to be reduced flexibly, and when the load is released, the inner diameter of the annular member 15 is configured to be elastically returned to an original dimension thereof.

On the other hand, as shown in FIGS. 12 and 13, a concave frustoconical guide surface 11t is formed on a part of an inside surface of the mouthpiece portion 11d of the shaft cylinder 11, as a guide surface having a tapered shape toward the front end side. Thus, in conjunction with a movement of the tip holder 33 toward a front end side thereof (FIG. 12→FIG. 13), the contact surface 15t is configured to receive the load from the guide surface 11t.

Furthermore, the projectable and retractable writing tool 30 according to the present embodiment is provided with a second coil spring 12 (second elastic member) in order to automatically retract the tip holder 33 when a retracting operation for the tip 34 (for example, a pushing operation of a push button provided on a rear end portion of the writing tool in order to release a locking mechanism that can maintain a projected state of the tip 34) is carried out. The second coil spring 12 is fitted into between a shoulder portion provided on the inside surface of the mouthpiece portion 11d and the first collar portion 33b of the collar member 32 such that the second coil spring 12 surrounds an outer periphery of the coil spring 16.

As shown in FIG. 15, the second coil spring 12 of the present embodiment is fixed to the inside surface of the mouthpiece portion 11d on a front end side thereof, and to the first collar portion 33b of the collar member 32 on a rear end side thereof. In this manner, the annular member 15 and the coil spring 16 are supported by and fixed to the inside surface of the mouthpiece portion 11d via the collar member 32 and the second coil spring 12.

The projectable and retractable writing tool 30 as described above operates as follows.

When not in use, the tip 34 (writing element) of the projectable and retractable writing tool 30 is retracted as shown in FIG. 12. A length of the coil spring 16 in an axial direction thereof is 10.6 mm and a length of the second coil spring 12 in an axial direction thereof is 15.9 mm. When a projecting operation for the tip 34 (for example, a pushing operation of a push button provided on the rear end portion of the writing tool) is carried out, the tip 34 (writing element) of the projectable and retractable writing tool 30 is projected as shown in FIG. 13. Usually, a position of the tip holder 33 is locked in this projected state. The projected state of the tip 34 is maintained until a retracting operation for the tip 34 is carried out thereafter. The length of the coil spring 16 in the axial direction thereof is 8.0 mm (shortened by 2.6 mm) and the length of the second coil spring 12 in the axial direction thereof is 8.9 mm (shortened by 7.0 mm).

During a transition from the retracted state shown in FIG. 12 to the projected state shown in FIG. 13, in conjunction with the movement of the tip holder 33 toward the front end side, the contact surface 15t of the annular member 15 receives a load from the guide surface 11t of the mouthpiece portion 11d. At this time, the inner diameter of the annular member 15 is reduced due to existence of the four slits 15s of the annular member 15 (FIG. 12→FIG. 13). As a result, as shown in FIG. 13, the mouthpiece portion 11d and the annular member 15 cooperate with each other such that the distal portion 33d of the tip holder 33 can be grasped in a rattling-free (play-free) manner.

In addition, since the tip holder 33 and the annular member 15 are connected via the coil spring 16 such that the tip holder 13 and the annular member 15 are movable relatively to each other, it can be assured that the distal portion 33d of the tip holder 33 can be effectively grasped in a rattling-free (play-free) manner even if no high-precision dimension management is applied to a degree of reduction of the inner diameter of the annular member 15 or the like.

Thereafter, when a retracting operation for the tip 34 (for example, a subsequent pushing operation of the push button provided on the rear end portion of the writing tool) is carried out, a locking mechanism not shown is released, so that the tip 34 (writing element) of the projectable and retractable writing tool 30 is returned to a retracted state shown in FIG. 12 by means of an action of the second coil spring 12.

During a transition from the projected state shown in FIG. 13 to the retracted state shown in FIG. 12, in conjunction with a movement of the tip holder 33 toward a rear end side, the load received by the contact surface 15t of the annular member 15 from the guide surface 11t of the mouthpiece portion 11d disappears. Thereby, the inner diameter of the annular member 15 that has been reduced is returned to an original dimension thereof (FIG. 13→FIG. 12).

As described above, according to the projectable and retractable writing tool 30 of the present embodiment, when the contact surface 15t of the annular member 15 receives the load from the guide surface 11t of the mouthpiece portion 11d in conjunction with the movement of the tip holder 33 toward the front end side, the inner diameter of the annular member 15 is reduced due to the existence of the slits 15s of the annular member 15. In this manner, the base potion 11d and the annular member 15 cooperate with each other such that the distal portion 33d of the tip holder 33 can be grasped in a rattling-free (play-free) manner. In addition, since the tip holder 33 and the annular member 15 are connected via the elastic member 16 such that the tip holder 33 and the annular member 15 are movable relatively to each other, it can be assured that the distal portion 33d of the tip holder 33 can be effectively grasped in a rattling-free (play-free) manner even if no high-precision dimension management is applied to a degree of reduction of the inner diameter of the annular member 15 or the like.

In addition, according to the projectable and retractable writing tool 30 of the present embodiment, since the four slits 15s as a cutout are arranged at regular intervals in a circumferential direction of the annular member 15 and each slit 15s extends in the axial direction of the annular member 15, the inner diameter of the annular member 15 can be reduced in a circumferentially well-balanced manner.

In addition, the contact surface 15t and the guide surface 11t have the frustoconical shape and the concave frustoconical shape which correspond to each other. Thus, the contact surface 15t of the annular member 15 can receive the load in a circumferentially well-balanced manner, so that the inner diameter of the annular member 15 can be reduced in a circumferentially well-balanced manner. Like this, it is preferable that the contact surface 15t and the guide surface 11t have tapered shapes toward the front end side. A tapered contact surface 15t may be formed by providing a rounded portion at an outer periphery of the front end of the cylindrical annular member 15. In addition, a tapered contact surface 15t may have a convex curved surface which is rotationally symmetric about an axis, and a tapered guide surface 11t may have a concave curved surface or a concave frustoconical surface which is also rotationally symmetric about the axis but has a curvature gentler than that of the convex curved surface.

In addition, in the projectable and retractable writing tool 30 of the present embodiment, the annular member 15 is movable in the axial direction in a region of the distal portion 33d of the tip holder 33, and the annular member 15 is configured to grasp the region of the distal portion 33d of the tip holder 33 when the inner diameter of the annular member 15 is reduced. However, the present invention is not limited thereto. For example, the annular member 15 may be movable in the axial direction in a region of the tip 34, and the annular member 15 may be configured to grasp the region of the tip 34 when the inner diameter of the annular member 15 is reduced.

In addition, it is possible to adjust elasticity (easiness of reduction of the inner diameter) of the annular member 15 by suitably changing the number of the slits 15s, the sizes of the slits 15s and/or the shapes of the slits 15s. In addition, it is also possible to adjust elasticity (easiness of reduction of the inner diameter) of the annular member 15 by changing a material and/or a thickness of the annular member 15.

In addition, according to the present embodiment, the annular member 15 and the collar member 32 are fixed to each other via the coil spring 16, and the collar member 32 and the mouthpiece portion 11d are fixed to each other via the second coil spring 12. That is to say, the annular member 15 need not to be fixed to the tip holder 33, and thus existing refills for replacement including conventional tip holders may be used as well.

Therefore, an invention of the present embodiment can be understood as a shaft cylinder for a projectable and retractable writing tool which can use existing refills for replacement. In this case, the present embodiment can be explained as a shaft cylinder 11 for a projectable and retractable writing tool, the shaft cylinder 11 being capable of containing a tip holder 33 such that the tip holder 33 is movable in an axial direction, a tip 34 being fixed to a front end of the tip holder 33, the shaft cylinder 11 having an opening at a front end thereof, through which the tip 34 is projectable and retractable in conjunction with a movement of the tip holder 33.

The shaft cylinder 11 includes an annular member 15 loosely fitted onto an outer periphery of the tip holder 33 or the tip 34 in a state wherein the shaft cylinder 11 contains the tip holder 33, to be movable in an axial direction of the tip holder 33 or the tip 34 with respect to the tip holder 33 or the tip 34 while being loosely fitted, a collar member 32 connected to the annular member 15 via a coil spring 16, the collar member 32 being capable of coming into contact with the tip holder 33, and a second coil spring 12 configured to support the collar member 32 on an inside surface of the shaft cylinder 11. A contact surface 15t is formed on at least a part of an outer periphery of the annular member 15, and slits 15s as a cutout are formed at a part of the annular member 15 such that an inner diameter of the annular member 15 is reduced when a load is received by the contact surface 15t. On the other hand, a guide surface 11t is formed on a part of an inside surface of the mouthpiece portion 11d of the shaft cylinder 11, the guide surface 11r is tapered toward a front end thereof, and the contact surface 15t is configured to receive the load from the guide surface 11t in conjunction with a movement of the tip holder 33 toward a front end side thereof.

According to the shaft cylinder 11 as described above, when the contact surface 15t of the annular member 15 receives the load from the guide surface 11t of the mouthpiece portion 11d in conjunction with the movement of the tip holder 33 toward the front end side, the inner diameter of the annular member 15 is reduced due to the existence of the slits 15s of the annular member 15. In this manner, the base potion 11d and the annular member 15 cooperate with each other such that the distal portion 33d of the tip holder 33 can be grasped in a rattling-free (play-free) manner. In addition, since the tip holder 33 and the annular member 15 are connected via the elastic member 16 such that the tip holder 33 and the annular member 15 are movable relatively to each other, it can be assured that the distal portion 33d of the tip holder 33 can be effectively grasped in a rattling-free (play-free) manner even if no high-precision dimension management is applied to a degree of reduction of the inner diameter of the annular member 15 or the like.

### Fourth Embodiment of First Invention

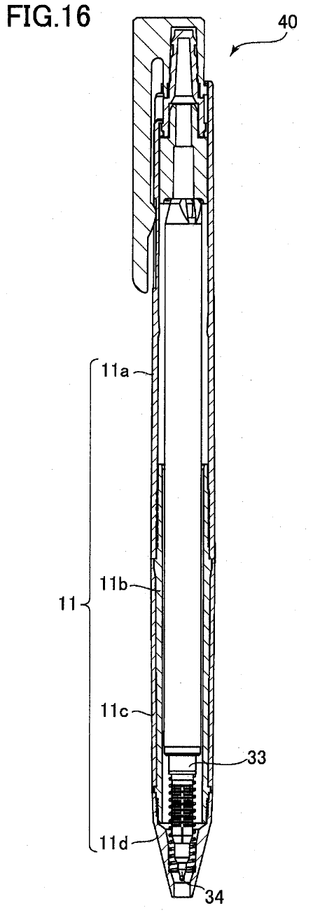

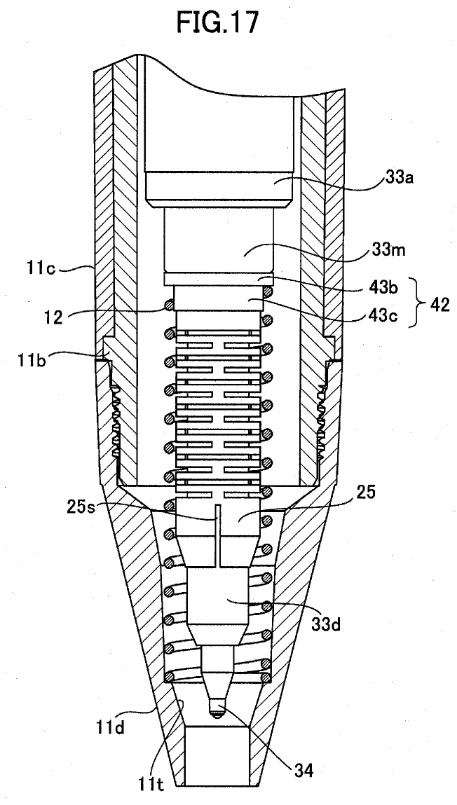

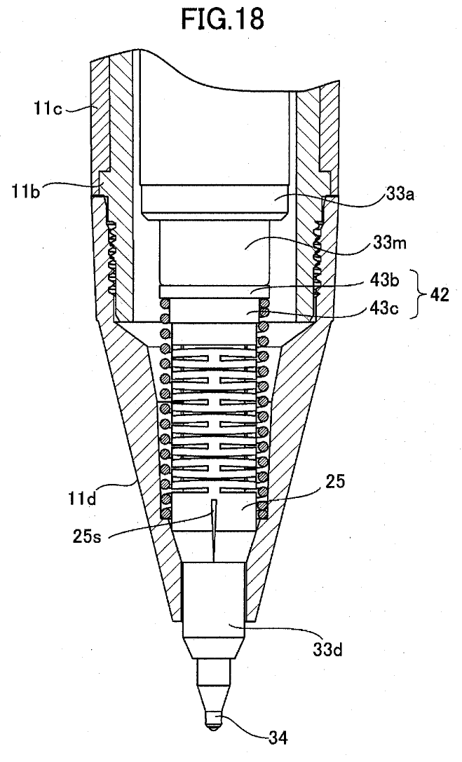

FIG. 16 is a schematic longitudinal section view showing a projectable and retractable writing tool 40 according to a fourth embodiment of the first invention under a state wherein a tip 34 (writing element) is not projected. FIG. 17 is an enlarged longitudinal section view of a leading edge portion of the projectable and retractable writing tool 40 according to the present embodiment. FIG. 18 is an enlarged longitudinal section view of the leading edge portion of the projectable and retractable writing tool 40 according to the present embodiment, under a state wherein the tip 34 (writing element) is projected.

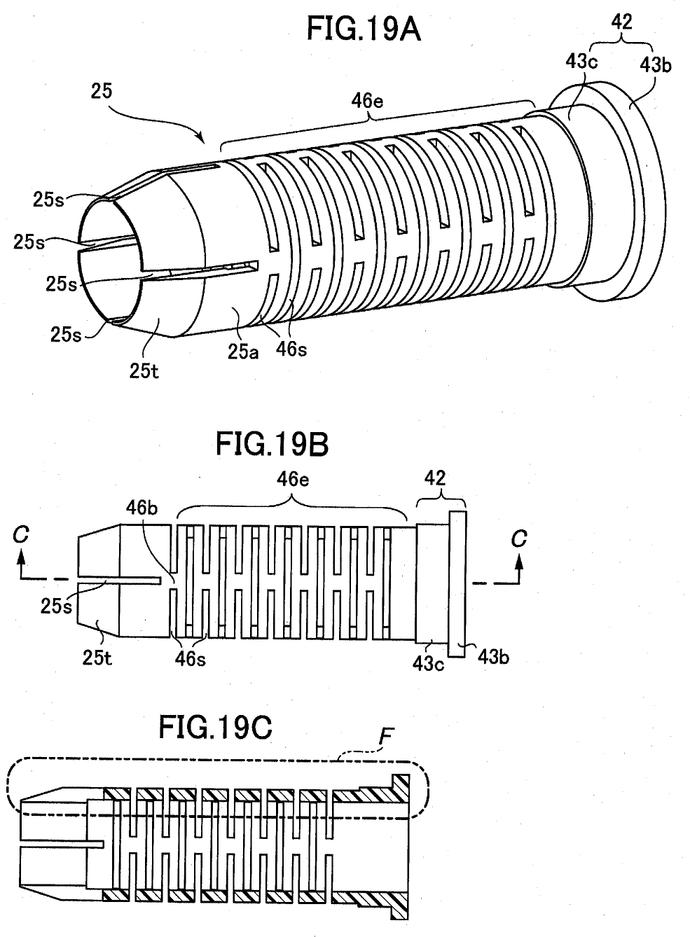

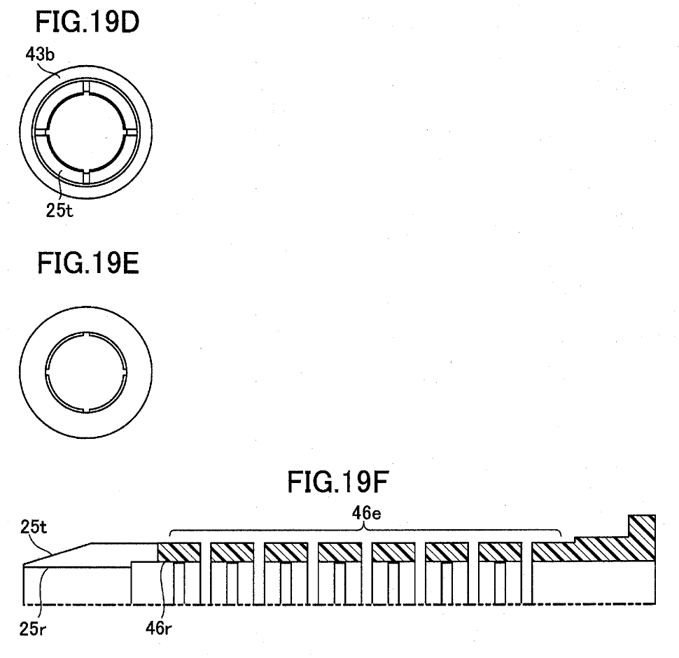

In addition, FIG. 19A is a perspective view of an annular member 25 and a collar member 42 of the projectable and retractable writing tool 40 according to the present embodiment, FIG. 19B is a side view of the annular member 25 and the collar member 42, FIG. 19C is a section view taken along line C-C of FIG. 19B, FIG. 19D is a front view (a view seen from the leading edge side) of the annular member 25 and the collar member 42, and FIG. 14E is a rear view of the annular member 25 and the collar member 42. Furthermore, FIG. 19F is an enlarged view of an F portion of FIG. 19C.

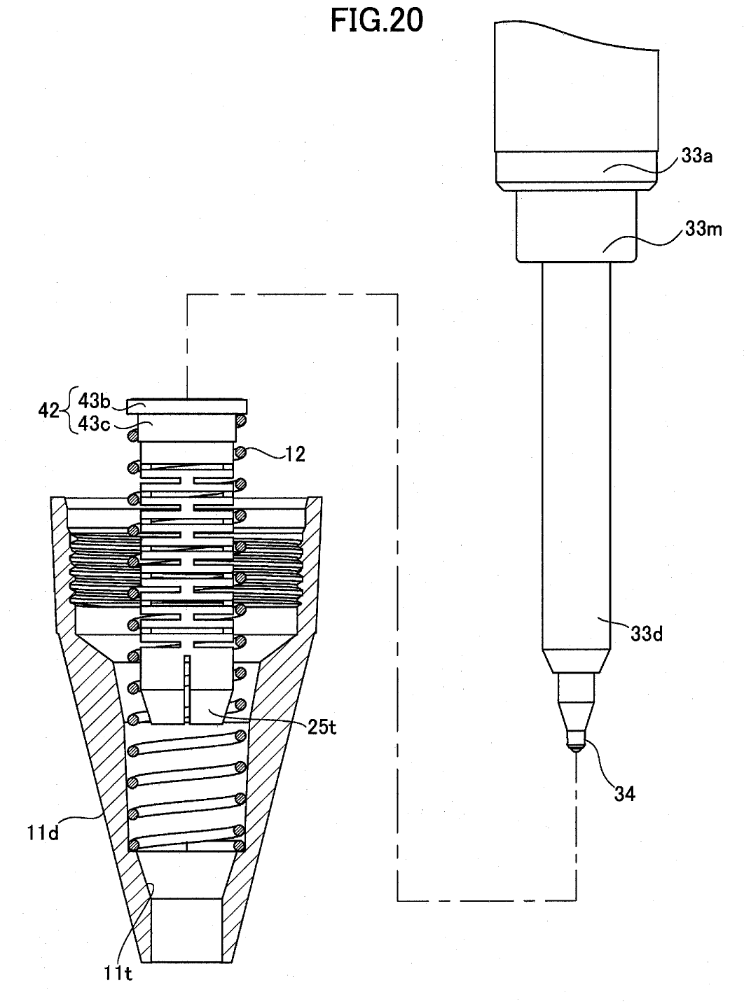

In addition, FIG. 20 is a schematic view showing the projectable and retractable writing tool 40 according to the present invention, under a state wherein the tip holder 33 has been removed for replacement or the like.

A tip holder 33 and the tip 34 of the present embodiment are respectively the same as the tip holder 33 and the tip 34 of the third embodiment. Thus, the same reference numbers are used for the corresponding members.

As well as the first to third embodiments, the projectable and retractable writing tool 40 according to the fourth embodiment shown in FIGS. 16 to 20 includes a shaft cylinder 11, which has an opening at a front end thereof and has a cylindrical shape. As shown in FIGS. 16 to 18, according to the present embodiment as well, the shaft cylinder 11 has a rear portion 11a, an inner cylindrical portion 11b, a front portion 11c and a mouthpiece portion 11d. The rear portion 11a and the inner cylindrical portion 11b are threadedly removably fixed to each other. The inner cylindrical portion 11b and the front portion 11c are integrally formed by two-color molding. Of course, the rear portion 11a and the inner cylindrical portion 11b may be fixed to each other by fitting connection or may be formed integrally. The inner cylindrical portion 11b and the front portion 11c may also be fixed by fitting connection. On the other hand, the mouthpiece portion 11d is threadedly detachably fixed to the inner cylindrical portion 11b. The material of the mouthpiece portion 11d is not limited to metal, but may be resin.

The tip holder 33, which is movable in an axial direction of the shaft cylinder 11, is contained in an inside of the shaft cylinder 11. The tip 34 as a writing element is fixed to a front end of the tip holder 33. The tip 34 is projectable and retractable through the opening of the shaft cylinder 11 in conjunction with a movement of the tip holder 33, as shown in FIGS. 17 and 18.

As well as the third embodiment, as shown in FIG. 20, the tip holder 33 includes: a proximal portion 33a, a middle collar portion 33m and a distal portion 33d, in this order from a proximal side thereof toward a distal side thereof. In the present embodiment as well, each of the proximal portion 33a, the middle collar portion 33m and the distal portion 33d has a cylindrical shape. The relationship between their cross-sectional diameters is as follows: the proximal portion 33a>the middle collar portion 33m>the distal portion 33d.

In the present embodiment, in particular as shown in FIG. 17, an annular member 25 made of resin (for example, polyacetal) is loosely fitted on an outer periphery of the distal portion 33d of the tip holder 33. As well as the second embodiment, the annular member 25 of the present embodiment is integrally molded with a tubular resin spring part 46e on a proximal end side thereof. A large number of slits 46s, each of which extends in a direction perpendicular to an axial direction, are formed in the resin spring part 46e, so that the resin spring part 46e can extend and contract in the axial direction.

As shown in FIGS. 19A to 19F, in the resin spring part 46e of the present embodiment, in substantially the same manner as the resin spring part 26e of the second embodiment, seven pairs of substantially semicircular slits 46s facing up and down (see FIG. 9F additionally) and seven pairs of substantially semicircular slits 46s facing left and right (see FIG. 9G additionally) are formed alternately in the axial direction. The remaining portion between the pairs of slits 46s is called a rib 46b. In the present embodiment, the width (the length in the axial direction) of each slit 46s is uniform, the axial gap between the slits 46s adjacent in the axial direction is also uniform, and the former is slightly smaller than the latter, Of course, these dimensional relationship may be suitably adjusted to achieve a desired degree of elasticity, as described below.

As shown in FIGS. 19A and 19B, a further proximal end side of the resin spring part 46e is fixed to a second collar portion 43c of the collar member 42. As shown in FIGS. 17 and 18, a first collar portion 43b of the collar member 42 is abutted and supported by the middle collar portion 33m of the tip holder 33 in the axial direction. In this manner, the annular member 25 is movable in an axial direction of the tip holder 33 with respect to the distal portion 33d of the tip holder 33, in conjunction with expansion and contraction of the resin spring part 46e.

In addition, in particular as shown in FIGS. 19A to 19E, as well as the second embodiment, a frustoconical contact surface 25t is formed on a front region of an outer periphery of the annular member 25, as a contact surface having a tapered shape toward the front end side. A cylindrical portion 25a is provided continuously on a rear side of the contact surface 25t. The tubular resin spring part 46e, whose diameter is the same as that of the cylindrical portion 25a, is provided on a further rear side thereof. In addition, in particular as shown in FIG. 19F, an inner diameter 46r of the resin spring part 46e is larger than an inner diameter 25r of a portion corresponding to the contact surface 25t.

In addition, as well as the second embodiment, the annular member 25 of the present embodiment is also provided with four slits (cutout elements) 25s as a cutout. As shown in FIGS. 19A to 19E, the four slits 25s are arranged at regular intervals (by every 90 degrees) in a circumferential direction of the annular member 25. Each of the four slits 25s extends from a front end of the annular member 25 to a vicinity of a rear end of the cylindrical portion 25a in an axial direction of the annular member 25. Thus, when a load is received by the contact surface 25t, an inner diameter of the annular member 25 is configured to be reduced flexibly, and when the load is released, the inner diameter of the annular member 25 is configured to be elastically returned to an original dimension thereof.

In addition, as shown in FIGS. 17 and 18, a concave frustoconical guide surface 11t is formed on a part of an inside surface of the mouthpiece portion 11d of the shaft cylinder 11, as a guide surface having a tapered shape toward the front end side. Thus, in conjunction with a movement of the tip holder 33 toward a front end side thereof (FIG. 17→FIG. 18), the contact surface 25t is configured to receive the load from the guide surface 11t.

Furthermore, the projectable and retractable writing tool 40 according to the present embodiment is also provided with a second coil spring 12 (second elastic member) in order to automatically retract the tip holder 33 when a retracting operation for the tip 34 (for example, a pushing operation of a push button provided on a rear end portion of the writing tool in order to release a locking mechanism that can maintain a projected state of the tip 34) is carried out. The second coil spring 12 is fitted into between a shoulder portion provided on the inside surface of the mouthpiece portion 11d and the first collar portion 43b of the collar member 42 such that the second coil spring 12 surrounds an outer periphery of the annular member 25.

As shown in FIG. 20, the second coil spring 12 of the present embodiment is fixed to the inside surface of the mouthpiece portion 11d on a front end side thereof, and to the first collar portion 43b of the collar member 42 on a rear end side thereof. In this manner, the annular member 25 is supported by and fixed to the inside surface of the mouthpiece portion 11d via the collar member 42 and the second coil spring 12.

The projectable and retractable writing tool 40 as described above operates as follows.

When not in use, the tip 34 (writing element) of the projectable and retractable writing tool 40 is retracted as shown in FIG. 17. A length of the annular member 25 including the resin spring part 46e in an axial direction thereof is 11.8 mm and a length of the second coil spring 12 in an axial direction thereof is 15.9 mm. When a projecting operation for the tip 34 (for example, a pushing operation of a push button provided on the rear end portion of the writing tool) is carried out, the tip 34 (writing element) of the projectable and retractable writing tool 40 is projected as shown in FIG. 18. Usually, a position of the tip holder 33 is locked in this projected state. The projected state of the tip 34 is maintained until a retracting operation for the tip 34 is carried out thereafter. The length of the annular member 25 including the resin spring part 46e in the axial direction thereof is 11.1 mm (shortened by 0.7 mm) and the length of the second coil spring 12 in the axial direction thereof is 8.9 mm (shortened by 7.0 mm).

During a transition from the retracted state shown in FIG. 17 to the projected state shown in FIG. 18, in conjunction with the movement of the tip holder 33 toward the front end side, the contact surface 25t of the annular member 25 receives a load from the guide surface 11t of the mouthpiece portion 11d. At this time, the inner diameter of the annular member 25 is reduced due to existence of the four slits 25s of the annular member 25 (see FIG. 3B). As a result, as shown in FIG. 18, the mouthpiece portion lid and the annular member 25 cooperate with each other such that the distal portion 33d of the tip holder 33 can be grasped in a rattling-free (play-free) manner.

In addition, since the tip holder 33 and the contact surface 25t of the annular member 25 are movable relatively to each other by means of expansion and contraction of the resin spring part 46e, it can be assured that the distal portion 33d of the tip holder 33 can be effectively grasped in .a rattling-free (play-free) manner even if no high-precision dimension management is applied to a degree of reduction of the inner diameter of the annular member 25 or the like.

Thereafter, when a retracting operation for the tip 34 (for example, a subsequent pushing operation of the push button provided on the rear end portion of the writing tool) is carried out, a locking mechanism not shown is released, so that the tip 34 (writing element) of the projectable and retractable writing tool 40 is returned to a retracted state shown in FIG. 17 by means of an action of the second coil spring 12.

During a transition from the projected state shown in FIG. 18 to the retracted state shown in FIG. 17, in conjunction with a movement of the tip holder 33 toward a rear end side, the load received by the contact surface 25t of the annular member 25 from the guide surface 11t of the mouthpiece portion 11d disappears. Thereby, the inner diameter of the annular member 25 that has been reduced is returned to an original dimension thereof (FIG. 18→FIG. 17).

As described above, according to the projectable and retractable writing tool 40 of the present embodiment, when the contact surface 25t of the annular member 25 receives the load from the guide surface 11t of the mouthpiece portion 11d in conjunction with the movement of the tip holder 33 toward the front end side, the inner diameter of the annular member 25 is reduced due to the existence of the slits 25s of the annular member 25. In this manner, the base potion 11d and the annular member 25 cooperate with each other such that the distal portion 33d of the tip holder 33 can be grasped in a rattling-free (play-free) manner. In addition, since the tip holder 23 and the contact surface 25t of the annular member 25 are movable relatively to each other by means of the resin spring part 46e, it can be assured that the distal portion 33d of the tip holder 33 can be effectively grasped in a rattling-free (play-free) manner even if no high-precision dimension management is applied to a degree of reduction of the inner diameter of the annular member 25 or the like.

In addition, since the inner diameter 46r of the resin spring part 46e is larger than the inner diameter 25r of the portion corresponding to the contact surface 25t, even if the resin spring part 46e swells toward an inner diameter side, the resin spring part 46e does not come into contact with the tip holder 33.

In addition, according to the projectable and retractable writing tool 40 of the present embodiment, since the four slits 25s as a cutout are arranged at regular intervals in a circumferential direction of the annular member 25 and each slit 25s extends in the axial direction of the annular member 25, the inner diameter of the annular member 25 can be reduced in a circumferentially well-balanced manner.

In addition, the contact surface 25t and the guide surface 11t have the frustoconical shape and the concave frustoconical shape which correspond to each other. Thus, the contact surface 25t of the annular member 25 can receive the load in a circumferentially well-balanced manner, so that the inner diameter of the annular member 25 can be reduced in a circumferentially well-balanced manner. Like this, it is preferable that the contact surface 25t and the guide surface 11t have tapered shapes toward the front end side. A tapered contact surface 25t may be formed by providing a rounded portion at an outer periphery of the front end of the cylindrical annular member 25. In addition, a tapered contact surface 25t may have a convex curved surface which is rotationally symmetric about an axis, and a tapered guide surface 11t may have a concave curved surface or a concave frustoconical surface which is also rotationally symmetric about the axis but has a curvature gentler than that of the convex curved surface.

In addition, in the projectable and retractable writing tool 40 of the present embodiment, the annular member 25 is movable in the axial direction in a region of the distal portion 33d of the tip holder 33, and the annular member 25 is configured to grasp the region of the distal portion 33d of the tip holder 33 when the inner diameter of the annular member 25 is reduced. However, the present invention is not limited thereto. For example, the annular member 25 may be movable in the axial direction in a region of the tip 34, and the annular member 25 may be configured to grasp the region of the tip 34 when the inner diameter of the annular member 25 is reduced.

In addition, it is possible to adjust elasticity (easiness of reduction of the inner diameter) of the annular member 25 by suitably changing the number of the slits 25s, the sizes of the slits 25s and/or the shapes of the slits 25s. In addition, it is also possible to adjust elasticity (easiness of reduction of the inner diameter) of the annular member 25 by suitably changing a material and/or a thickness of the annular member 25.

In addition, it is possible to adjust elasticity (easiness of expansion and contraction) of the resin spring part 46e by suitably changing the number of the slits 46s, the sizes of the slits 46s and/or the shapes of the slits 46s. It is preferable that the slits 46s extend in the direction perpendicular to the axial direction. However, they may extend obliquely (for example, spirally) with respect to the axial direction.

In addition, it is also possible to adjust elasticity (easiness of expansion and contraction) of the resin spring part 46e by changing a thickness of the resin spring part 46e. Furthermore, the resin spring part 46e may be formed as a resin spring member separate from the contact surface 25t and the cylindrical portion 25a, and may be joined to the cylindrical portion 25a. In this case, it is also possible to adjust elasticity (easiness of expansion and contraction) of the resin spring member by changing a material of the resin spring member.

Furthermore, the resin spring part 46e (or a separate resin spring member) is not limited to the configuration having the slit 46s, but may be a configuration having a bellows structure that expands and contracts in the axial direction.

In addition, according to the present embodiment, the resin spring part 46e of the annular member 25 and the collar member 42 are fixed to each other, and the collar member 42 and the mouthpiece portion 11d are fixed to each other via the second coil spring 12. That is to say, the annular member 25 need not to be fixed to the tip holder 33, and thus existing refills for replacement including conventional tip holders may be used as well.

Therefore, an invention of the present embodiment can also be understood as a shaft cylinder for a projectable and retractable writing tool which can use existing refills for replacement. In this case, the present embodiment can also be explained as a shaft cylinder 11 for a projectable and retractable writing tool, the shaft cylinder 11 being capable of containing a tip holder 33 such that the tip holder 33 is movable in an axial direction, a tip 34 being fixed to a front end of the tip holder 33, the shaft cylinder 11 having an opening at a front end thereof, through which the tip 34 is projectable and retractable in conjunction with a movement of the tip holder 33.

The shaft cylinder 11 includes an annular member 25 loosely fitted onto an outer periphery of the tip holder 33 or the tip 34 in a state wherein the shaft cylinder 11 contains the tip holder 33, to be movable in an axial direction of the tip holder 33 or the tip 34 with respect to the tip holder 33 or the tip 34 while being loosely fitted, a collar member 42 connected to a further proximal side of a resin spring part 46e which is a part on a proximal side of the annular member 25, the collar member 42 being capable of coming into contact with the tip holder 33, and a second coil spring 12 configured to support the collar member 42 on an inside surface of the shaft cylinder 11. A contact surface 25t is formed on at least a part of an outer periphery of the annular member 25, and slits 25s as a cutout are formed at a part of the annular member 25 such that an inner diameter of the annular member 25 is reduced when a load is received by the contact surface 25t. On the other hand, a guide surface 11t is formed on a part of an inside surface of the mouthpiece portion 11d of the shaft cylinder 11, the guide surface 11r is tapered toward a front end thereof, and the contact surface 25t is configured to receive the load from the guide surface 11t in conjunction with a movement of the tip holder 33 toward a front end side thereof.

According to the shaft cylinder 11 as described above, when the contact surface 25t of the annular member 25 receives the load from the guide surface 11t of the mouthpiece portion lid in conjunction with the movement of the tip holder 33 toward the front end side, the inner diameter of the annular member 25 is reduced due to the existence of the slits 25s of the annular member 25. In this manner, the base potion 11d and the annular member 25 cooperate with each other such that the distal portion 33d of the tip holder 33 can be grasped in a rattling-free (play-free) manner. In addition, since the tip holder 33 and the annular member 25 are movable relatively to each other by means of the resin spring part 46e, it can be assured that the distal portion 33d of the tip holder 33 can be effectively grasped in a rattling-free (play-free) manner even if no high-precision dimension management is applied to a degree of reduction of the inner diameter of the annular member 25 or the like.

### An Embodiment of Second Invention

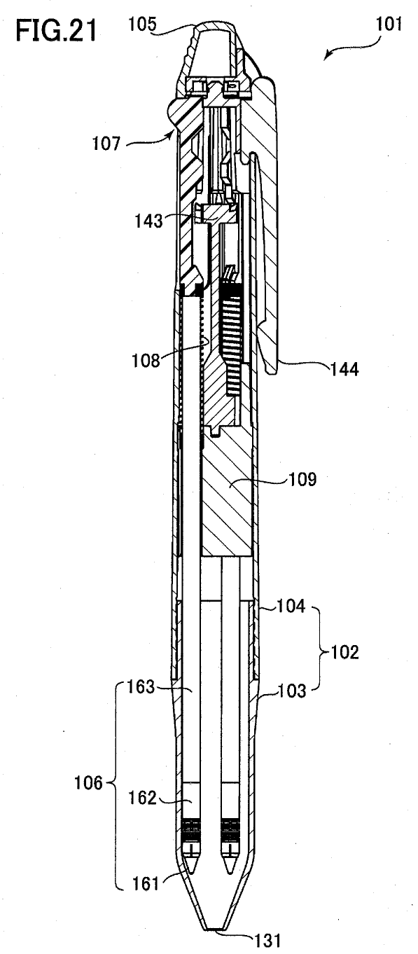

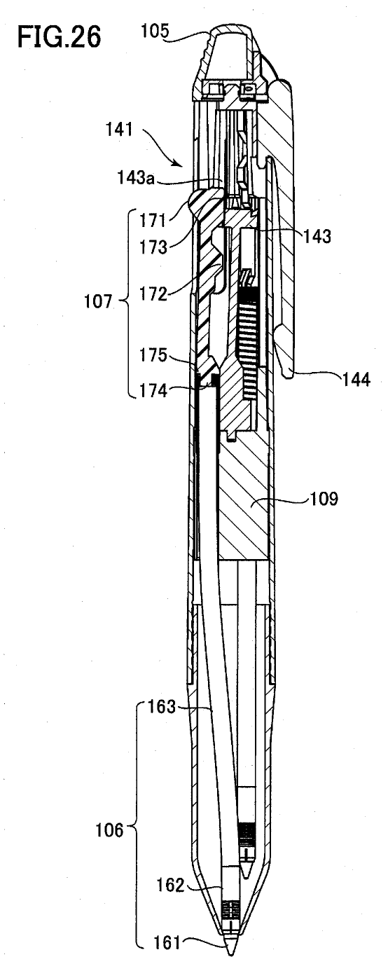

FIG. 21 is a schematic longitudinal section view showing a multi-tip writing tool 101 according to an embodiment of a second invention, under a state wherein all tips (writing elements) are not projected. On the other hand, FIG. 26 is a schematic longitudinal section view showing the multi-tip writing tool 101 shown in FIG. 21, under a state wherein one ball-point pen tip as an example of writing element is projected.

As shown in FIGS. 21 and 26, the multi-tip writing tool 101 of the present embodiment includes a shaft cylinder 102, which consists of a front shaft 103 having a tapered cylindrical shape and a rear shaft 104 threadedly engaged with or press-fitted in a rear end portion of the front shaft 103. An opening 131 is provided at a front end of the front shaft 103 in an axial direction, through which a tip 161 of a writing element 106 is projectable. The front shaft 103 and the rear shaft 104 are made of synthetic resin (for example, polycarbonate) or metal.

For example, five (selectable from two to six) elongated window holes 141, each of which extends in a front and rear direction (see FIG. 26), are provided at a side wall of a rear portion of the rear shaft 104 in radial directions. For example, the five window holes 141 are formed at regular intervals in a circumferential direction.

A release bar 143 extends in a front and rear direction at a region on a shaft center side inside the five window holes 141 of the rear shaft 104. A front end of the release bar 143 is supported by a spring supporter 109, which is described below. On the other hand, locking walls 143a extending in a front and rear direction are formed on an inside surface of the side wall between the five window holes 141 of the rear shaft 104. Each locking wall 143a can lock a rear end of an operational element 107 of a corresponding writing element 106 under a state wherein a tip thereof is projected. Under the state wherein the rear end of the operational element 107 of the writing element 106 is locked on a corresponding locking wall 143a with the tip being projected, when another operational element 107 of another writing element 106 is moved forward in order to project the latter writing element 106, the latter operational element 107 presses the release bar 143 radially outward, and thus the pressed release bar 143 presses the rear end of the former operational element 107, which has been locked on the locking wall 143a, radially outward so that the locked state is released. In addition, a clip 144 is provided on an outside surface of the side wall between the five window holes 141 of the rear shaft 104.

A cap 105 is pivotably provided on a rear end portion of the rear shaft 104 such that the rear end portion can be freely opened and closed. For example, an end portion of the cap 105 may be pivotably connected to a proximal portion of the clip 144 via a hinge element. The hinge element may extend in a right and left direction of the clip 144 when the clip 144 is seen from a front side thereof under an orientation wherein the tip is located below. In this case, the cap 105 may be pivotable in a substantially front and rear direction.

An abutment wall part is formed on a front surface of the cap 105. A rear end of the operational element 107 connected to a rear end of a writing element 106 under a retracted state thereof is adapted to be abutted and stopped by the abutment wall part (see FIG. 21). As a hinge element, typically, a structure connected pivotably by means of a pivotable shaft may be adopted. However, instead of this manner, a joint element or the like, which has such a flexibility that the same is bendable, may be also adopted.

For example, an engaging part (for example, an engagement recess or an engagement hole) may be provided on a front surface of the other end portion of the cap 105. An engaged part (for example, an engagement protrusion), which can be engaged with the engaging part, may be provided at a rear end of the rear shaft 104. In detail, an inward protrusion may be formed on an inside surface of the engaging part (the engagement recess or the engagement hole), and an outward protrusion which can climb over the inward protrusion to be locked may be formed on an outside surface of the engaged part (the engagement protrusion).

In this case, while the cap 105 closes the opening of the rear end, the engaging part and the engaged part are engaged with each other (the inward protrusion and the outward protrusion are climbed over each other to be locked). This engaged state is not released by a contact between the operational element 107 and the cap 105 caused by a rearward biasing force of a coil spring 108 which is described below. Thus, the cap 105 is not opened.

In particular as shown in FIG. 26, each operational element 107 includes an operational part 171, a front projected part 172, a rear projected part 173, a fitting-in part 174 and a flange part 175. The operational part 171 is formed at a rear end portion of the operational element 107, and projected outward from a corresponding window hole 141 of the shaft cylinder 102. The rear projected part 173 is provided on an opposite side of the operational part 171 (on a shaft center side) of the operational element 107. The front projected part 172 is provided on a front side of the rear projected part 173. The fitting-in part 174 is formed at a front end of the operational element 107 and fitted in a rear end opening of an ink containing cylinder 163. The flange part 175 is formed in a vicinity of a rear end of the fitting-in part 174. A front surface of the flange part 175 is pressing a rear end of a coil spring 108.

Locking protrusions (not shown) are formed on both side surfaces of each operational element 107. The locking protrusions can be slidably retained in both side walls of each window hole 141. The operational element 107 may be obtained by a molded body of synthetic resin (for example, a polypropylene resin, an ABS resin, a polyacetal resin, or the like).

When the tip 161 of the writing element 106 is in a retracted state, the rear end portion of the operational element 107 attached to the writing element 106 is adapted to be abutted and stopped by the abutment wall part (see FIG. 21). On the other hand, when the tip 161 of the writing element 106 is in a projected state, the rear projected part 173 of the operational element 107 attached to the writing element 106 is adapted to be locked by the locking wall 143a formed inside the shaft cylinder 102 (see FIG. 26).

In addition, in a state wherein the tip 161 of a writing element 106 is retracted and the tip 161 of another writing element 106 is projected, when the operational part 171 of the operational element 107 connected to the former writing element 106 is operated to slide forward, the front projected part 172 of the operational element 107 is adapted to press the release bar 143 that has been abutted by the rear projected part 173 of the operational element 107 connected to the latter writing element 106, and to release the locked state between the rear projected part 173 and the locking wall 143a, i.e., to release the projected state of the tip 161 of the latter writing element 106.

On the other hand, a cylindrical spring supporter 109 is provided in the shaft cylinder 102 (in the rear shaft 104). Five inside holes are formed through the spring supporter 109 in an axial direction, and a corresponding writing element 106 is inserted through each of the five inside holes. A coil spring 108 is arranged on a rear surface side of the spring supporter 109, correspondingly to each inside hole. The writing element 106 is loosely inserted through each inside hole and through an inside of each coil spring 108. The front surface of the flange part 175 of the operational element 107 is pressing a rear end of the coil spring 108.

More specifically, a cylindrical concave portion is formed on a rear end surface of the spring supporter 109, correspondingly to each inside hole. A front end outside surface of each coil spring 108 is press-fitted into each cylindrical concave portion. Thus, when a writing element 106 (and a corresponding operational element 107) is replaced, it is prevented that a corresponding coil spring 108 is picked out during the replacement operation.

Each coil spring 108 always biases each operational element 107 (and thus each writing element 106) rearward. That is to say, each coil spring 108 maintains a compressed state thereof (a state wherein the writing element 106 is biased rearward) both in a tip projected state and in a tip retracted state. This prevents rattling of the operational element 107 in the front and rear direction. However, each coil spring 108 is in a non-compressed (free) state under a condition wherein no writing element 106 is inserted into the inside thereof (for example, during a replacement operation of the writing element).

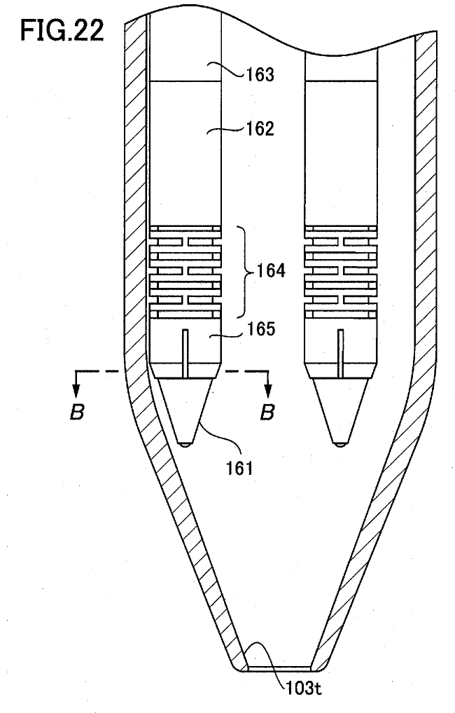

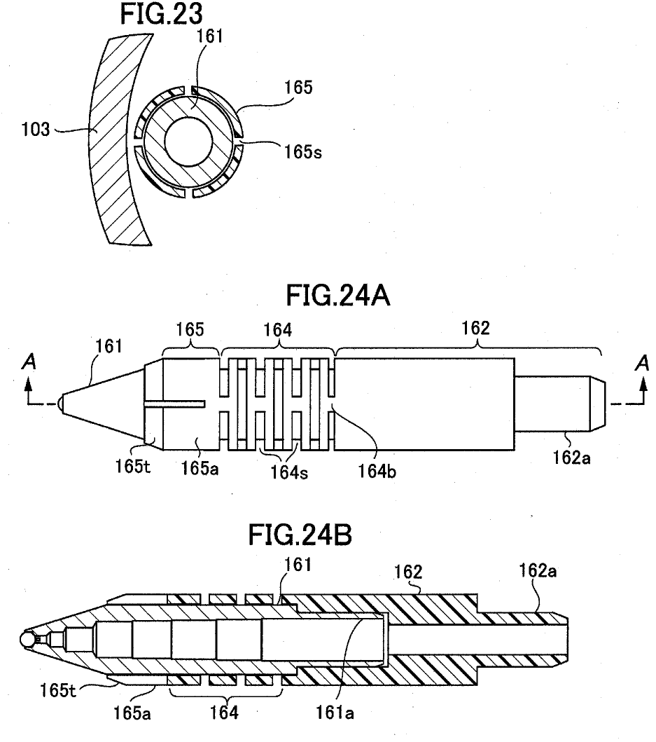

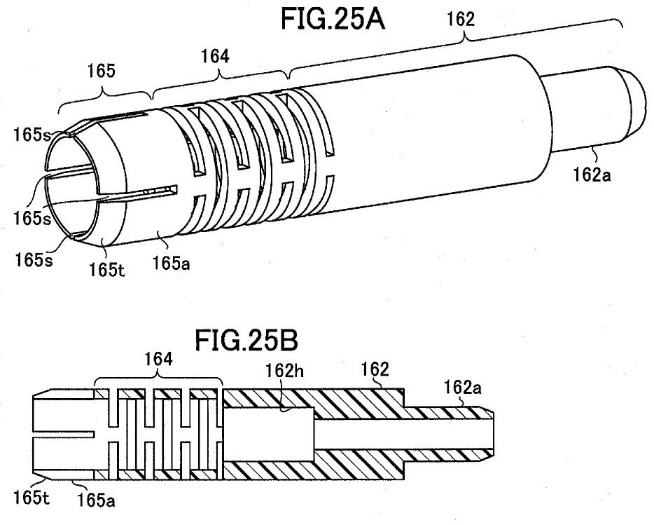

Next, FIG. 22 is an enlarged longitudinal section view of a leading edge portion of the multi-tip writing tool 101 shown in FIG. 21, and FIG. 23 is a section view taken along line B-B of FIG. 22. FIG. 24A is a side view of the tip 161, a tip holder 162, an annular member 165 and an elastic member 164 of the multi-tip writing tool 101 shown in FIG. 21, and FIG. 24B is a section view taken along line A-A of FIG. 24A. FIG. 25A is a perspective view of the tip holder 162, the annular member 165 and the elastic member 164 of the multi-tip writing tool 101 shown in FIG. 21, and FIG. 25B is a longitudinal section view of the tip holder 162, the annular member 165 and the elastic member 164 shown in FIG. 25A.

As shown in FIGS. 25A and 25B, in the present embodiment, the tip holder 162, the annular member 165 and the elastic member 164 are integrally molded. A rear end portion of the tip holder 162 is a small diameter portion 162a to fit into a front end portion of the ink containing cylinder 163. On the other hand, as shown in FIGS. 24B and 25B, a front end portion of the tip holder 162 is provided with a fitting-in hole 162h into which a small diameter portion 161a at a rear end of the tip 161 is fitted. The tip 161 of the present embodiment is a ball-point pen tip.

In addition, in particular as shown in FIGS. 23 and 24B, an annular member 165 made of resin (for example, polyacetal) is loosely fitted on an outer periphery of the tip 161. The annular member 165 of the present embodiment is integrally molded with a tubular resin spring member 164 on a proximal end side thereof. A large number of slits 164s, each of which extends in a direction perpendicular to an axial direction, are formed in the resin spring member 164, so that the resin spring member 164 can extend and contract in the axial direction.

As shown in FIGS. 24A, 24B, 25A and 25B, in the resin spring member 164 of the present embodiment, four pairs of substantially semicircular slits 164s facing up and down and three pairs of substantially semicircular slits 164s facing left and right are formed alternately in the axial direction. The remaining portion between the pairs of slits 164s called a rib 164b. In the present embodiment, the width (the length in the axial direction) of each slit 164s is uniform, the axial gap between the slits 164s adjacent in the axial direction is also uniform, and the former is the same as the latter. Of course, these dimensional relationship may be suitably adjusted to achieve a desired degree of elasticity, as described below.

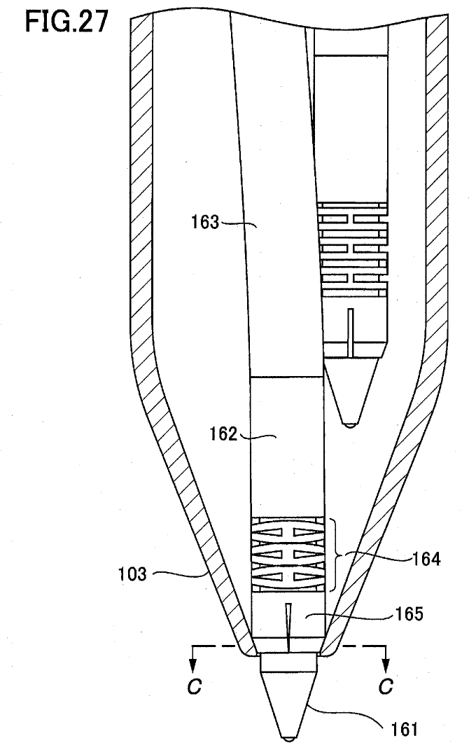

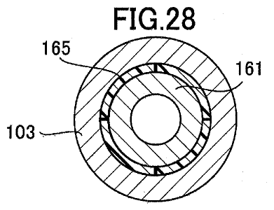

A further proximal end side of the resin spring member 164 is integral with a front end side of the tip holder 162. In this manner, as shown in FIG. 27, the annular member 165 is movable in an axial direction of the tip 161 with respect to the tip 161, in conjunction with expansion and contraction of the resin spring member 164.

In addition, in particular as shown in FIG. 25A, a frustoconical contact surface 165t is formed on a front region of an outer periphery of the annular member 165, as a contact surface having a tapered shape toward the front end side. A cylindrical portion 165a is provided continuously on a rear side of the contact surface 165t. The tubular resin spring member 164, whose diameter is the same as that of the cylindrical portion 165a, is provided on a further rear side thereof. In the present embodiment, an inner diameter of the resin spring member 164 is the same as an inner diameter of a portion corresponding to the contact surface 165t.

The annular member 165 of the present embodiment is provided with four slits (cutout elements) 165s as a cutout. As shown in FIG. 25A, the four slits 165s are arranged at regular intervals (by every 90 degrees) in a circumferential direction of the annular member 165. Each of the four slits 165s extends from a front end of the annular member 165 to a vicinity of a rear end of the cylindrical portion 165a in an axial direction of the annular member 165. Thus, when a load is received by the contact surface 165t, an inner diameter of the annular member 165 is configured to be reduced flexibly, and when the load is released, the inner diameter of the annular member 165 is configured to be elastically returned to an original dimension thereof.

In addition, as shown in FIG. 22, a concave frustoconical guide surface 103t is formed in a vicinity of the opening 131 of the front shaft 103, as a guide surface having a tapered shape toward the front end side. Thus, in conjunction with a movement of the writing element 106 toward a front end side thereof (FIG. 21→FIG. 26), the contact surface 165t is configured to receive the load from the guide surface 103t.

The multi-tip writing tool 101 as described above operates as follows.

As shown in FIGS. 21 and 22, under a state wherein all the writing elements 106 are retracted, when the operational part 171 of an operational element 107 is selected and operated to slide forward along a corresponding window hole 141 against a rearward biasing force of the coil spring 108, the tip 161 of the writing element 106 connected to the operated operational element 107 is projected outward from the opening 131 of the shaft cylinder 102. Then, the rear rejected part 173 of the operated operational element 107 is newly locked by the locking wall 143a inside the shaft cylinder 102, so that the tip projected state is maintained.

Alternatively, under a state wherein another writing element 106 is projected, when the operational part 171 of an operational element 107 is selected and operated to slide forward along a corresponding window hole 141 against a rearward biasing force of the coil spring 108, the front projected part 172 of the operated operational element 107 radially outward presses the release bar 143 that has been abutted by the rear projected part 173 of the operational element 107 connected to the former writing element 106. Thus, the locked state between the locking wall 143a and the rear projected part 173 is released, and thus the former writing element 106 is moved rearward by a biasing force of a corresponding coil spring 108, i.e., retracted in the shaft cylinder 102. At the same time that the latter writing element 106 is retracted, the tip 161 of the writing element 106 connected to the operated operational element 107 is projected outward from the opening 131 of the shaft cylinder 102. Then, the rear rejected part 173 of the operated operational element 107 is newly locked by the locking wall 143a inside the shaft cylinder 102, so that the tip projected state is maintained.

FIG. 27 is an enlarged longitudinal section view of a leading edge portion of the multi-tip writing tool 101 shown in FIG. 26, and FIG. 28 is a section view taken along line C-C of FIG. 27. As shown in FIGS. 26 to 28, in either of the above cases, in conjunction with the movement of the writing element 106 toward the front end side, the contact surface 165t of the annular member 165 receives a load from the guide surface 103t of the front shaft 103. At this time, the inner diameter of the annular member 165 is reduced due to existence of the four slits 165s of the annular member 165. As a result, as shown in FIG. 28, the front shaft 103 and the annular member 165 cooperate with each other such that the tip 161 can be grasped in a rattling-free (play-free) manner.

In addition, since the tip holder 162 and the contact surface 165t of the annular member 165 are movable relatively to each other by means of expansion and contraction of the resin spring member 164, it can be assured that the tip 161 can be effectively grasped in a rattling-free (play-free) manner even if no high-precision dimension management is applied to a degree of reduction of the inner diameter of the annular member 165 or the like.

Thereafter, when a tip 161 that has been projected so far is retracted rearward by a rearward biasing force of a corresponding coil spring 108, for example in conjunction with a projecting operation for another writing element 106, the load received by the contact surface 165t of the annular member 165 from the guide surface 103t of the front shaft 103 disappears. Thereby, the inner diameter of the annular member 165 that has been reduced is returned to an original dimension thereof (FIG. 28→FIG. 23).

In addition, when a writing element 106 is replaced, an operational end of the cap 105 on the opposite side of the hinge element is pushed rearward to release the engagement between the engaging part and the engaged part and to pivot the cap 105 rearward, from a state wherein the cap 105 closes the rear end opening of the shaft cylinder 102 (see FIG. 21). Thereby, the rear end opening of the shaft cylinder 102 is opened. At the same time as this, each operational element 107 is projected rearward from the opening by a rearward biasing force of a corresponding coil spring 108. In this state, any operational element 107 can be picked out, thereby the writing element 106 connected to the operational element 107 can be picked out from the shaft cylinder 102.

Thereafter, a new writing element 106 (and a corresponding new operational element 107) is inserted in the shaft cylinder 102 through the rear end opening. Subsequently, the cap 105 is pivoted forward such that each operational element 107 is abutted and pressed forward by the abutment wall part of the cap 105, and the engaging part and the engaged part are engaged with each other such that the cap 105 is closed. In conjunction with this, the front surface of the flange part 175 of the new operational element 107 presses a rear end of a corresponding coil spring 108. Thereby, a replacement operation for the writing element 106 (and the operational element 107) is completed.

As described above, according to the multi-tip writing tool 101 of the present embodiment, when the contact surface 165t of the annular member 165 receives the load from the guide surface 103t of the front shaft 103 in conjunction with the movement of the writing element 106 (including the tip holder 162) toward the front end side, the inner diameter of the annular member 165 is reduced due to the existence of the slits 165s of the annular member 165. In this manner, the front shaft 103 and the annular member 165 cooperate with each other such that the tip 161 can be grasped in a rattling-free (play-free) manner. In addition, since the tip 161 and the contact surface 165t of the annular member 165 are movable relatively to each other by means of the resin spring member 164, it can be assured that the tip 161 can be effectively grasped in a rattling-free (play-free) manner even if no high-precision dimension management is applied to a degree of reduction of the inner diameter of the annular member 165 or the like.

In addition, according to the multi-tip writing tool 101 of the present embodiment, since the four slits 165s as a cutout are arranged at regular intervals in a circumferential direction of the annular member 165 and each slit 165s extends in the axial direction of the annular member 165, the inner diameter of the annular member 165 can be reduced in a circumferentially well-balanced manner.

In addition, the contact surface 165t and the guide surface 103t have the frustoconical shape and the concave frustoconical shape which correspond to each other. Thus, the contact surface 165t of the annular member 165 can receive the load in a circumferentially well-balanced manner, so that the inner diameter of the annular member 165 can be reduced in a circumferentially well-balanced manner. Like this, it is preferable that the contact surface 165t and the guide surface 103t have tapered shapes toward the front end side. A tapered contact surface 165t may be formed by providing a rounded portion at an outer periphery of the front end of the cylindrical annular member 165. In addition, a tapered contact surface 165t may have a convex curved surface which is rotationally symmetric about an axis, and a tapered guide surface 103t may have a concave curved surface or a concave frustoconical surface which is also rotationally symmetric about the axis but has a curvature gentler than that of the convex curved surface.

In addition, in the multi-tip writing tool 101 of the present embodiment, the annular member 165 is movable in the axial direction in a region of the tip 161, and the annular member 165 is configured to grasp the region of the tip 161 when the inner diameter of the annular member 165 is reduced. However, the present invention is not limited thereto. For example, the annular member 165 may be movable in the axial direction in a region of a separate member (for example, a tip holder) holding the tip 161, and the annular member 165 may be configured to grasp the region of the separate member when the inner diameter of the annular member 165 is reduced.

In addition, it is possible to adjust elasticity (easiness of reduction of the inner diameter) of the annular member 165 by suitably changing the number of the slits 165s, the sizes of the slits 165s and/or the shapes of the slits 165s. In addition, it is also possible to adjust elasticity (easiness of reduction of the inner diameter) of the annular member 165 by suitably changing a material and/or a thickness of the annular member 165.

In addition, it is possible to adjust elasticity (easiness of expansion and contraction) of the resin spring member 164 by suitably changing the number of the slits 164s, the sizes of the slits 164s and/or the shapes of the slits 164s. It is preferable that the slits 164s extend in the direction perpendicular to the axial direction. However, they may extend obliquely (for example, spirally) with respect to the axial direction.

In addition, it is also possible to adjust elasticity (easiness of expansion and contraction) of the resin spring member 164 by changing a thickness of the resin spring member 164. Furthermore, the resin spring member 164 may be formed as a resin spring member separate from the annular member 165 (the contact surface 165t and the cylindrical portion 165a), and may be joined to the cylindrical portion 165a. In this case, it is also possible to adjust elasticity (easiness of expansion and contraction) of the resin spring member by changing a material of the resin spring member.

Furthermore, the resin spring member 164 (or a separate resin spring member) is not limited to the configuration having the slit 164s, but may be a configuration having a bellows structure that expands and contracts in the axial direction.

A plurality of types of refills for replacement having different refill diameters (diameters of the tip 161, the tip holder 162 and/or the ink containing cylinder 163) may be used in any mixed state.

In addition, instead of a writing element, a refill holding a friction member as a tip 161 may be used. The friction member means an eraser or a frictional heat generating rubber for a thermochromic writing tool (a rubber for erasing). In this case, it is possible to prevent rattling of the friction member when erasing a written trace, and thus to obtain a more stable erasing feeling.

In the above explanation, as a mechanism for moving the tip holder 162 toward the front end side, a manner of allowing the operational part 171 of the operational element 107 to slide is adopted. However, instead of this manner, a so-called rotary feeding mechanism may be adopted.

### An Embodiment of Third Invention

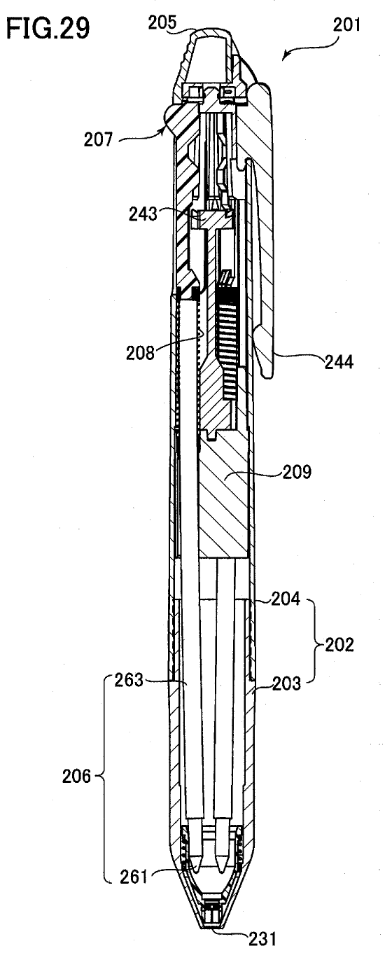

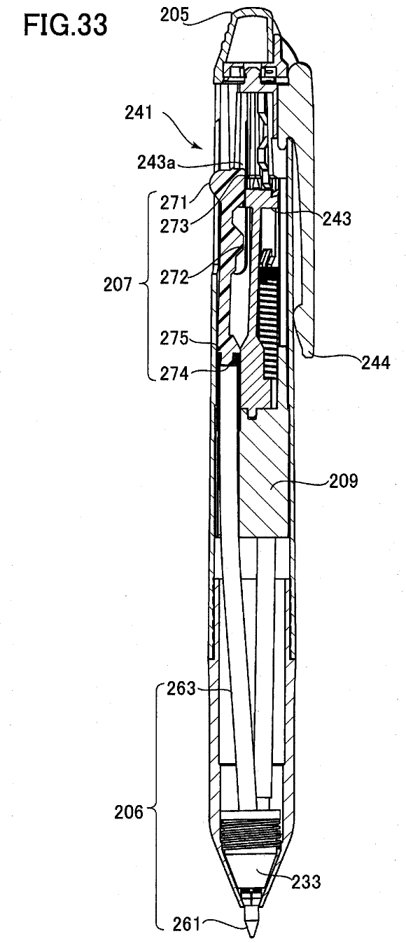

FIG. 29 is a schematic longitudinal section view showing a multi-tip writing tool 201 according to an embodiment of a third invention, under a state wherein all tips (writing elements) are not projected. On the other hand, FIG. 33 is a schematic longitudinal section view showing the multi-tip writing tool 201 shown in FIG. 29, under a state wherein one ball-point pen tip as an example of writing element is projected.

As shown in FIGS. 29 and 33, the multi-tip writing tool 201 of the present embodiment includes a shaft cylinder 202, which consists of a front shaft 203 having a tapered cylindrical shape and a rear shaft 204 threadedly engaged with or press-fitted in a rear end portion of the front shaft 203. An opening 231 is provided at a front end of the front shaft 203 in an axial direction, through which a tip 261 of a writing element 206 is projectable. The front shaft 203 and the rear shaft 204 are made of synthetic resin (for example, polycarbonate) or metal.

For example, five (selectable from two to six) elongated window holes 241, each of which extends in a front and rear direction (see FIG. 33), are provided at a side wall of a rear portion of the rear shaft 204 in radial directions. For example, the five window holes 241 are formed at regular intervals in a circumferential direction.

A release bar 243 extends in a front and rear direction at a region on a shaft center side inside the five window holes 241 of the rear shaft 204. A front end of the release bar 243 is supported by a spring supporter 209, which is described below. On the other hand, locking walls 243a extending in a front and rear direction are formed on an inside surface of the side wall between the five window holes 241 of the rear shaft 204. Each locking wall 243a can lock a rear end of an operational element 207 of a corresponding writing element 206 under a state wherein a tip thereof is projected. Under the state wherein the rear end of the operational element 207 of the writing element 206 is locked on a corresponding locking wall 243a with the tip being projected, when another operational element 207 of another writing element 206 is moved forward in order to project the latter writing element 206, the latter operational element 207 presses the release bar 243 radially outward, and thus the pressed release bar 243 presses the rear end of the former operational element 207, which has been locked on the locking wall 243a, radially outward so that the locked state is released. In addition, a clip 244 is provided on an outside surface of the side wall between the five window holes 241 of the rear shaft 204.

A cap 205 is pivotably provided on a rear end portion of the rear shaft 204 such that the rear end portion can be freely opened and closed. For example, an end portion of the cap 205 may be pivotably connected to a proximal portion of the clip 244 via a hinge element. The hinge element may extend in a right and left direction of the clip 244 when the clip 244 is seen from a front side thereof under an orientation wherein the tip is located below. In this case, the cap 205 may be pivotable in a substantially front and rear direction.

An abutment wall part is formed on a front surface of the cap 205. A rear end of the operational element 207 connected to a rear end of a writing element 206 under a retracted state thereof is adapted to be abutted and stopped by the abutment wall part (see FIG. 29). As a hinge element, typically, a structure connected pivotably by means of a pivotable shaft may be adopted. However, instead of this manner, a joint element or the like, which has such a flexibility that the same is bendable, may be also adopted.

For example, an engaging part (for example, an engagement recess or an engagement hole) may be provided on a front surface of the other end portion of the cap 205. An engaged part (for example, an engagement protrusion), which can be engaged with the engaging part, may be provided at a rear end of the rear shaft 204. In detail, an inward protrusion may be formed on an inside surface of the engaging part (the engagement recess or the engagement hole), and an outward protrusion which can climb over the inward protrusion to be locked may be formed on an outside surface of the engaged part (the engagement protrusion).

In this case, while the cap 205 closes the opening of the rear end, the engaging part and the engaged part are engaged with each other (the inward protrusion and the outward protrusion are climbed over each other to be locked). This engaged state is not released by a contact between the operational element 207 and the cap 205 caused by a rearward biasing force of a coil spring 208 which is described below. Thus, the cap 205 is not opened.

In particular as shown in FIG. 33, each operational element 207 includes an operational part 271, a front projected part 272, a rear projected part 273, a fitting-in part 274 and a flange part 275. The operational part 271 is formed at a rear end portion of the operational element 207, and projected outward from a corresponding window hole 241 of the shaft cylinder 202. The rear projected part 273 is provided on an opposite side of the operational part 271 (on a shaft center side) of the operational element 207. The front projected part 272 is provided on a front side of the rear projected part 273. The fitting-in part 274 is formed at a front end of the operational element 207 and fitted in a rear end opening of a tip holder 263 which also serves as an ink containing cylinder. The flange part 275 is formed in a vicinity of a rear end of the fitting-in part 274. A front surface of the flange part 275 is pressing a rear end of a coil spring 208.

Locking protrusions (not shown) are formed on both side surfaces of each operational element 207. The locking protrusions can be slidably retained in both side walls of each window hole 241. The operational element 207 may be obtained by a molded body of synthetic resin (for example, a polypropylene resin, an ABS resin, a polyacetal resin, or the like).

When the tip 261 of the writing element 206 is in a retracted state, the rear end portion of the operational element 207 attached to the writing element 206 is adapted to be abutted and stopped by the abutment wall part (see FIG. 29). On the other hand, when the tip 261 of the writing element 206 is in a projected state, the rear projected part 273 of the operational element 207 attached to the writing element 206 is adapted to be locked by the locking wall 243a formed inside the shaft cylinder 202 (see FIG. 33).

In addition, in a state wherein the tip 261 of a writing element 206 is retracted and the tip 261 of another writing element 206 is projected, when the operational part 271 of the operational element 207 connected to the former writing element 206 is operated to slide forward, the front projected part 272 of the operational element 207 is adapted to press the release bar 243 that has been abutted by the rear projected part 273 of the operational element 207 connected to the latter writing element 206, and to release the locked state between the rear projected part 273 and the locking wall 243a, i.e., to release the projected state of the tip 261 of the latter writing element 206.

On the other hand, a cylindrical spring supporter 209 is provided in the shaft cylinder 202 (in the rear shaft 204). Five inside holes are formed through the spring supporter 209 in an axial direction, and a corresponding writing element 206 is inserted through each of the five inside holes. A coil spring 208 is arranged on a rear surface side of the spring supporter 209, correspondingly to each inside hole. The writing element 206 is loosely inserted through each inside hole and through an inside of each coil spring 208. The front surface of the flange part 275 of the operational element 207 is pressing a rear end of the coil spring 208.

More specifically, a cylindrical concave portion is formed on a rear end surface of the spring supporter 209, correspondingly to each inside hole. A front end outside surface of each coil spring 208 is press-fitted into each cylindrical concave portion. Thus, when a writing element 206 (and a corresponding operational element 207) is replaced, it is prevented that a corresponding coil spring 208 is picked out during the replacement operation.

Each coil spring 208 always biases each operational element 207 (and thus each writing element 206) rearward. That is to say, each coil spring 208 maintains a compressed state thereof (a state wherein the writing element 206 is biased rearward) both in a tip projected state and in a tip retracted state. This prevents rattling of the operational element 207 in the front and rear direction. However, each coil spring 208 is in a non-compressed (free) state under a condition wherein no writing element 206 is inserted into the inside thereof (for example, during a replacement operation of the writing element).

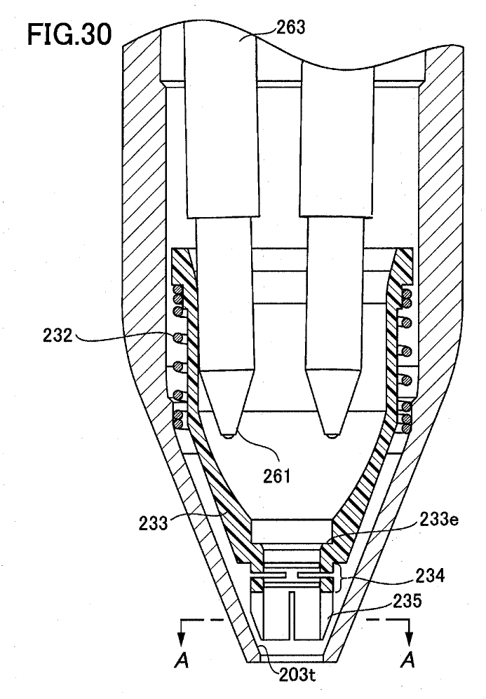

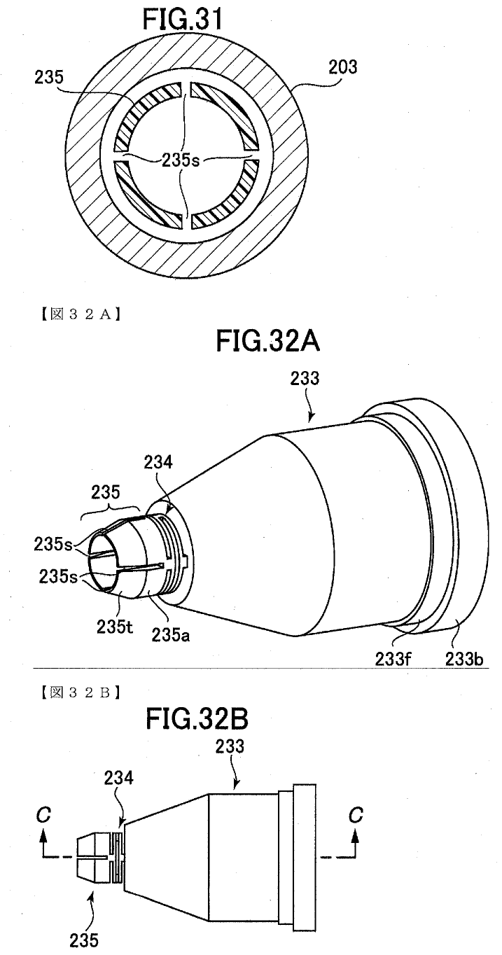

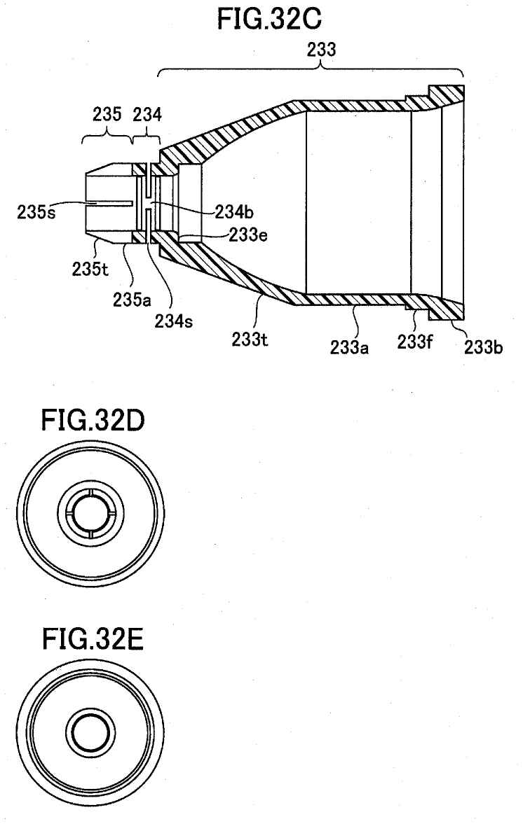

Next, FIG. 30 is an enlarged longitudinal section view of a leading edge portion of the multi-tip writing tool 201 shown in FIG. 29, and FIG. 31 is a section view taken along line A-A of FIG. 30. In addition, FIG. 32A is a perspective view of an annular member 235, an elastic member 234 and a collar member 233 of the multi-tip writing tool 201 shown in FIG. 29, FIG. 32B is a side view of the annular member 235, the elastic member 234 and the collar member233, FIG. 32C is a section view taken along line C-C of FIG. 32B, FIG. 33D is a front view (a view seen from the leading edge side) of the annular member 235, the elastic member 234 and the collar member 233, and FIG. 32E is a rear view of the annular member 235, the elastic member 234 and the collar member 233.

As shown in FIGS. 29, 30, 33 and 34, the multi-tip writing tool 201 of the present embodiment is provided with an annular member 235 (for example, made of polyacetal), which can be loosely fitted on an outer periphery of the tip 261 fixed to one tip holder 263 among the plurality of tip holders (ink containing cylinders) 263 in conjunction with a movement of the tip holder 263 toward a front end side thereof to be movable in an axial direction of the tip 261 with respect to the tip 261 while being loosely fitted.

In particular as shown in FIGS. 32A and 32C, a frustoconical contact surface 235t is formed on a front region of an outer periphery of the annular member 235, as a contact surface having a tapered shape toward the front end side. A cylindrical portion 235a is provided continuously on a rear side of the contact surface 235t. The tubular resin spring member 234, whose diameter is the same as that of the cylindrical portion 235a, is integrally molded on a further rear side thereof. In the present embodiment, an inner diameter of the resin spring member 234 is the same as an inner diameter of a portion corresponding to the contact surface 235t.

A plurality of slits 234s, each of which extends in a direction perpendicular to an axial direction, are formed in the resin spring member 234, so that the resin spring member 234 can extend and contract in the axial direction. Specifically, as shown in FIGS. 30, 32A and 32C, in the resin spring member 234 of the present embodiment, two pairs of substantially semicircular slits 234s facing up and down and one pair of substantially semicircular slits 234s facing left and right are formed alternately in the axial direction. The remaining portion between the pairs of slits 234s called a rib 234b. In the present embodiment, the width (the length in the axial direction) of each slit 234s is uniform, the axial gap between the slits 234s adjacent in the axial direction is also uniform, and the former is the same as the latter. Of course, these dimensional relationship may be suitably adjusted to achieve a desired degree of elasticity, as described below.

A further proximal end side of the resin spring member 234 is integrally molded with the collar member 233. In particular as shown in FIG. 32C, the collar member 233 generally consists of a tapered cylindrical body. A rear end portion of the collar member 233 is provided with a rear end collar portion 233b whose diameter is larger. As shown in FIG. 30, the rear end collar portion 233b is fixed to an inside surface of the front shaft 203 via a coil spring 232. In addition, the collar member 233 of the present embodiment is provided with a spring fixation assisting portion 233f in order to assist in fixing the coil spring 232 to the rear end collar portion 233b.

That is to say, the collar member 233 has the rear end collar portion 233b, the spring fixation assisting portion 233f, a main portion 233a and a tapered portion 233t, in this order from a proximal side thereof toward a distal side thereof. In the present embodiment, each of the rear end collar portion 233b, the spring fixation assisting portion 233f and the main portion 233a has a cylindrical shape. The relationship between their cross-sectional diameters is as follows: the rear end collar portion 233b>the spring fixation assisting portion 233f>the main portion 233a.

In addition, as shown in FIGS. 30 and 32C, an enlarged inner diameter portion 233e is provided on an inside surface side of the tapered portion 233t such that a front end portion of the tip holder 263 (ink containing cylinder) having a diameter larger than that of a rear end portion of the tip 261 can come in contact with the enlarged inner diameter portion 233e. Thereby, in conjunction with a movement of the tip holder 263 toward a front end side thereof, the front end portion of the tip holder 263 comes in contact with the enlarged inner diameter portion 233e and presses the collar member 233 toward the front end side while compressing the coil spring 232.

The annular member 235 of the present embodiment is provided with four slits (cutout elements) 235s as a cutout. As shown in FIG. 32A, the four slits 235s are arranged at regular intervals (by every 90 degrees) in a circumferential direction of the annular member 235. Each of the four slits 235s extends from a front end of the annular member 235 to a vicinity of a rear end of the cylindrical portion 235a in an axial direction of the annular member 235. Thus, when a load is received by the contact surface 235t, an inner diameter of the annular member 235 is configured to be reduced flexibly, and when the load is released, the inner diameter of the annular member 235 is configured to be elastically returned to an original dimension thereof.

On the other hand, as shown in FIG. 30, a concave frustoconical guide surface 203t is formed in a vicinity of the opening 231 of the front shaft 203, as a guide surface having a tapered shape toward the front end side. Thus, in conjunction with a movement of the writing element 206 toward a front end side thereof, when the collar member 233 and the annular member 235 are moved toward the front end side (FIG. 29→FIG. 33), the contact surface 235t is configured to receive the load from the guide surface 203t. Thereby, because of the load, the inner diameter of the annular member 235 is reduced due to the existence of the slits 235s, and the annular member 235 is moved in an axial direction of the tip 261 with respect to the tip 261 in conjunction with contraction of the resin spring member 234.

The multi-tip writing tool 201 as described above operates as follows.

As shown in FIGS. 29 and 30, under a state wherein all the writing elements 206 are retracted, when the operational part 271 of an operational element 207 is selected and operated to slide forward along a corresponding window hole 241 against a rearward biasing force of the coil spring 208, the front end portion of the tip holder 263 of the writing element 206 connected to the operated operational element 207 causes the collar member 233 to move toward the front end side against the coil spring 232 via the enlarged inner diameter portion 233e, and thus the tip 261 of the writing element 206 is projected outward from the opening 231 of the shaft cylinder 202. Then, the rear rejected part 273 of the operated operational element 207 is newly locked by the locking wall 243a inside the shaft cylinder 202, so that the tip projected state is maintained.

Alternatively, under a state wherein another writing element 206 is projected, when the operational part 271 of an operational element 207 is selected and operated to slide forward along a corresponding window hole 241 against a rearward biasing force of the coil spring 208, the front projected part 272 of the operated operational element 207 radially outward presses the release bar 243 that has been abutted by the rear projected part 273 of the operational element 207 connected to the former writing element 206. Thus, the locked state between the locking wall 243a and the rear projected part 273 is released, and thus the former writing element 206 is moved rearward by a biasing force of a corresponding coil spring 208, i.e., retracted in the shaft cylinder 202. At the same time that the latter writing element 206 is retracted, the front end portion of the tip holder 263 of the writing element 206 connected to the operated operational element 207 causes the collar member 233 to move toward the front end side against the coil spring 232 via the enlarged inner diameter portion 233e, and thus the tip 261 of the writing element 206 is projected outward from the opening 231 of the shaft cylinder 202. Then, the rear rejected part 273 of the operated operational element 207 is newly locked by the locking wall 243a inside the shaft cylinder 202, so that the tip projected state is maintained.

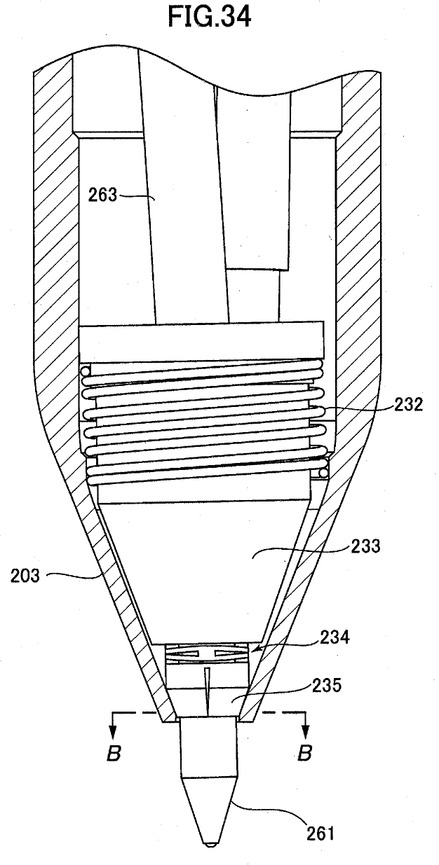

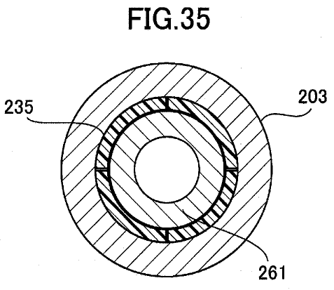

FIG. 34 is an enlarged longitudinal section view of a leading edge portion of the multi-tip writing tool 201 shown in FIG. 33, and FIG. 35 is a section view taken along line B-B of FIG. 34. As shown in FIGS. 33 to 35, in either of the above cases, in conjunction with the movement of the writing element 206 toward the front end side, the contact surface 235t of the annular member 235 receives a load from the guide surface 203t of the front shaft 203. At this time, the inner diameter of the annular member 235 is reduced due to existence of the four slits 235s of the annular member 235. As a result, as shown in FIG. 35, the front shaft 203 and the annular member 235 cooperate with each other such that the tip 261 can be grasped in a rattling-free (play-free) manner.

In addition, since the collar member 233 engaged with the tip holder 263 holding the tip 261 via the enlarged inner diameter portion 233e and the contact surface 235t of the annular member 235 are movable relatively to each other by means of expansion and contraction of the resin spring member 234, it can be assured that the tip 261 can be effectively grasped in a rattling-free (play-free) manner even if no high-precision dimension management is applied to a degree of reduction of the inner diameter of the annular member 235 or the like.

Thereafter, when a tip 261 that has been projected so far is retracted rearward by a rearward biasing force of a corresponding coil spring 208, for example in conjunction with a projecting operation for another writing element 206, the collar member 233 is also returned to an original position thereof by a restoring force of the coil spring 232. Thereby, the load received by the contact surface 235t of the annular member 235 from the guide surface 203t of the front shaft 203 disappears, and thus the inner diameter of the annular member 235 that has been reduced is returned to an original dimension thereof (FIG. 35→FIG. 31).

In addition, when a writing element 206 is replaced, an operational end of the cap 205 on the opposite side of the hinge element is pushed rearward to release the engagement between the engaging part and the engaged part and to pivot the cap 205 rearward, from a state wherein the cap 205 closes the rear end opening of the shaft cylinder 202 (see FIG. 29). Thereby, the rear end opening of the shaft cylinder 202 is opened. At the same time as this, each operational element 207 is projected rearward from the opening by a rearward biasing force of a corresponding coil spring 208. In this state, any operational element 207 can be picked out, thereby the writing element 206 connected to the operational element 207 can be picked out from the shaft cylinder 202.

Thereafter, a new writing element 206 (and a corresponding new operational element 207) is inserted in the shaft cylinder 202 through the rear end opening. Subsequently, the cap 205 is pivoted forward such that each operational element 207 is abutted and pressed forward by the abutment wall part of the cap 205, and the engaging part and the engaged part are engaged with each other such that the cap 205 is closed. In conjunction with this, the front surface of the flange part 275 of the new operational element 207 presses a rear end of a corresponding coil spring 208. Thereby, a replacement operation for the writing element 206 (and the operational element 207) is completed.

As described above, according to the multi-tip writing tool 201 of the present embodiment, when the annular member 235 is moved toward the front end side via the collar member 233 (including the enlarged inner diameter portion 233e) and the resin spring member 234 and then the contact surface 235t of the annular member 235 receives the load from the guide surface 203t of the front shaft 203 in conjunction with the movement of the writing element 206 (including the tip holder 263) toward the front end side, the inner diameter of the annular member 235 is reduced due to the existence of the slits 235s of the annular member 235. In this manner, the front shaft 203 and the annular member 235 cooperate with each other such that the tip 261 can be grasped in a rattling-free (play-free) manner. In addition, since the collar member 233 abutted by the tip holder 263 and the annular member 235 are connected via the resin spring member 234, it can be assured that the tip 261 can be effectively grasped in a rattling-free (play-free) manner even if no high-precision dimension management is applied to a degree of reduction of the inner diameter of the annular member 235 or the like.

In addition, according to the multi-tip writing tool 201 of the present embodiment, since the four slits 235s as a cutout are arranged at regular intervals in a circumferential direction of the annular member 235 and each slit 235s extends in the axial direction of the annular member 235, the inner diameter of the annular member 235 can be reduced in a circumferentially well-balanced manner.

In addition, the contact surface 235t and the guide surface 203t have the frustoconical shape and the concave frustoconical shape which correspond to each other. Thus, the contact surface 235t of the annular member 235 can receive the load in a circumferentially well-balanced manner, so that the inner diameter of the annular member 235 can be reduced in a circumferentially well-balanced manner. Like this, it is preferable that the contact surface 235t and the guide surface 203t have tapered shapes toward the front end side. A tapered contact surface 235t may be formed by providing a rounded portion at an outer periphery of the front end of the cylindrical annular member 235. In addition, a tapered contact surface 235t may have a convex curved surface which is rotationally symmetric about an axis, and a tapered guide surface 203t may have a concave curved surface or a concave frustoconical surface which is also rotationally symmetric about the axis but has a curvature gentler than that of the convex curved surface.

In addition, in the multi-tip writing tool 201 of the present embodiment, the annular member 235 is movable in the axial direction in a region of the tip 261, and the annular member 235 is configured to grasp the region of the tip 261 when the inner diameter of the annular member 235 is reduced. However, the present invention is not limited thereto. For example, the annular member 235 may be movable in the axial direction in a region of a separate member (for example, a tip holder) holding the tip 261, and the annular member 235 may be configured to grasp the region of the separate member when the inner diameter of the annular member 235 is reduced.

In addition, it is possible to adjust elasticity (easiness of reduction of the inner diameter) of the annular member 235 by suitably changing the number of the slits 235s, the sizes of the slits 235s and/or the shapes of the slits 235s. In addition, it is also possible to adjust elasticity (easiness of reduction of the inner diameter) of the annular member 235 by suitably changing a material and/or a thickness of the annular member 235.

In addition, it is possible to adjust elasticity (easiness of expansion and contraction) of the resin spring member 234 by suitably changing the number of the slits 234s, the sizes of the slits 234s and/or the shapes of the slits 234s. It is preferable that the slits 234s extend in the direction perpendicular to the axial direction. However, they may extend obliquely (for example, spirally) with respect to the axial direction.

In addition, it is also possible to adjust elasticity (easiness of expansion and contraction) of the resin spring member 234 by changing a thickness of the resin spring member 234. Furthermore, the resin spring member 234 may be formed as a resin spring member separate from the annular member 235 (the contact surface 235t and the cylindrical portion 235a), and may be joined to the cylindrical part 235a. In this case, it is also possible to adjust elasticity (easiness of expansion and contraction) of the resin spring member by changing a material of the resin spring member.

Furthermore, the resin spring member 234 (or a separate resin spring member) is not limited to the configuration having the slit 234s, but may be a configuration having a bellows structure that expands and contracts in the axial direction.

A plurality of types of refills for replacement having different refill diameters (diameters of the tip 261 and/or the tip holder 263) may be used in any mixed state.

In addition, instead of a writing element, a refill holding a friction member as a tip 261 may be used. The friction member means an eraser or a frictional heat generating rubber for a thermochromic writing tool (a rubber for erasing). In this case, it is possible to prevent rattling of the friction member when erasing a written trace, and thus to obtain a more stable erasing feeling.

In addition, according to the present embodiment, the annular member 235, the resin spring member 234 and the collar member 233 are fixed to each other, and the collar member 233 and the front shaft 203 are fixed to each other via the coil spring 232. That is to say, the annular member 235 need not to be fixed to the writing element 206, and thus existing refills for replacement including conventional tip holders may be used as well.

Therefore, an invention of the present embodiment can be understood as a shaft cylinder for a multi-tip writing tool which can use existing refills for replacement. In this case, the present embodiment can be explained as a shaft cylinder 202 for a multi-tip writing tool, the shaft cylinder 202 being capable of containing a plurality of tip holders 263 such that each of the plurality of tip holders 263 is movable in an axial direction, a tip 261 being fixed to a front end of each of the plurality of tip holders 263, the shaft cylinder 202 having an opening at a front end thereof, through which the tip 261 fixed to one tip holder 236 among the plurality of tip holders 263 is projectable and retractable in conjunction with a movement of the one tip holder 236.

The shaft cylinder 202 includes an annular member 235, which can be loosely fitted on an outer periphery of the tip 261 fixed to one tip holder 263 in conjunction with a movement of the one tip holder 263 toward a front end side thereof to be movable in an axial direction of the tip 261 with respect to the tip 261 while being loosely fitted, a collar member 233 connected to the annular member 235 via a resin spring member 234, the collar member 233 being capable of coming into contact with the one tip holder 263 in conjunction with the movement of the one tip holder 263 toward the front end side, and a coil spring 232 configured to support the collar member 233 on an inside surface of the front shaft 203. A contact surface 235t is formed on at least a part of an outer periphery of the annular member 235, and slits 235s as a cutout are formed at a part of the annular member 235 such that an inner diameter of the annular member 235 is reduced when a load is received by the contact surface 235t. On the other hand, a guide surface 203t is formed on a part of an inside surface of the front shaft 203, the guide surface 203t is tapered toward a front end thereof. When the annular member 235 is moved toward the front end side via the collar member 233 and the elastic member 234 in conjunction with the movement of the one tip holder 263 toward the front end side, the contact surface 235t is configured to receive the load from the guide surface 203t.

According to the shaft cylinder 202 as described above, when the annular member 235 is moved toward the front end side via the collar member 233 (including the enlarged inner diameter portion 233e) and the resin spring member 234 and then the contact surface 235t of the annular member 235 receives the load from the guide surface 203t of the front shaft 203 in conjunction with the movement of the writing element 296 (including the tip holder 263) toward the front end side, the inner diameter of the annular member 235 is reduced due to the existence of the slits 235s of the annular member 235. In this manner, the front shaft 203 and the annular member 235 cooperate with each other such that the tip 261 can be grasped in a rattling-free (play-free) manner. In addition, since the collar member 233 abutted by the tip holder 263 and the annular member 235 are connected via the resin spring member 234, it can be assured that the tip 261 can be effectively grasped in a rattling-free (play-free) manner even if no high-precision dimension management is applied to a degree of reduction of the inner diameter of the annular member 235 or the like.

In the above explanation, as a mechanism for moving the tip holder 263 toward the front end side, a manner of allowing the operational part 271 of the operational element 207 to slide is adopted. However, instead of this manner, a so-called rotary feeding mechanism may be adopted.

### EXPLANATION OF SIGN

10, 20, 30, 40 projectable and retractable writing tool
11 shaft cylinder (common in respective embodiments)
11a rear portion
11b inner cylindrical portion
11c front portion
11d mouthpiece portion
11t guide surface
12 second coil spring (example of second elastic member: common in respective embodiments)
13 tip holder (first embodiment)
13a proximal portion
13b first collar portion
13c second collar portion
13d distal portion
13f spring fixation assisting portion
14 tip (writing element) (first embodiment)
15 annular member (common in first and third embodiments)
15a large outer diameter cylindrical portion
15b small outer diameter cylindrical portion
15t contact surface
15s slit
16 coil spring (example of elastic member: common in first and third embodiments)
23 tip holder (second embodiment)
23a proximal portion
23b first collar portion
23c second collar portion
23d distal portion
24 tip (writing element) (second embodiment)
25 annular member (common in second and fourth embodiments)
25a cylindrical portion
25t contact surface
25s slit
25r inner diameter
26e resin spring part (example of elastic member: second embodiment)
26s slit
26b rib
26r inner diameter
32 collar member
33 tip holder (common in third and fourth embodiments)
33a proximal portion
33m middle collar portion
33d distal portion
33b first collar portion
33c second collar portion
34 tip (writing element) (common in third and fourth embodiments)
42 collar member
43b first collar portion
43c second collar portion
46e resin spring part (example of elastic member: fourth embodiment)
46s slit
46b rib
46r inner diameter
101 multi-tip writing tool
102 shaft cylinder
103 front shaft
103t guide surface
131 opening
104 rear shaft
141 window hole
143 release bar
143a locking wall
144 clip
105 cap
106 writing element (ball-point pen)
161 tip
161a small diameter portion
162 tip holder
162a small diameter portion
162h fitting-in hole
163 ink containing cylinder
164 resin spring member (example of elastic member)
164s slit
164b rib
165 annular member
165s slit
165t contact surface
165a cylindrical portion
107 operational element
171 operational part
172 front projected part
173 rear projected part
174 fitting-in part
175 flange part
108 coil spring
109 spring supporter
201 multi-tip writing tool
202 shaft cylinder
203 front shaft
203t guide surface
231 opening
232 coil spring (example of second elastic member)
233 collar member (example of annular collar)
233a main portion
233t tapered portion
233b rear end collar portion
233e enlarged inner diameter portion
233f spring fixation assisting portion
234 resin spring member (example of elastic member)
234s slit
234b rib
235 annular member
235s slit
235t contact surface
235a cylindrical portion
204 rear shaft
241 window hole
243 release bar
243a locking wall
244 clip
205 cap
206 writing element (ball-point pen)
261 tip
263 tip holder (ink containing cylinder)
207 operational element
271 operational part
272 front projected part
273 rear projected part
274 fitting-in part
275 flange part
208 coil spring
209 spring supporter

1. A projectable and retractable writing tool comprising:
a shaft cylinder having an opening at a front end thereof,
a tip holder contained in an inside of the shaft cylinder and movable in an axial direction of the shaft cylinder,
a tip fixed to a front end of the tip holder to be projectable and retractable through the opening of the shaft cylinder in conjunction with a movement of the tip holder,
an annular member loosely fitted onto an outer periphery of the tip holder or the tip to be movable in an axial direction of the tip holder or the tip with respect to the tip holder or the tip, and
an elastic member connecting the tip holder and the annular member such that the tip holder and the annular member are movable relatively to each other,
wherein
a contact surface is formed on at least a part of an outer periphery of the annular member, the contact surface being configured to come into contact with a part of an inside surface of the shaft cylinder in conjunction with a movement of the tip holder toward a front end side thereof,
a cutout is formed at a part of the annular member such that an inner diameter of the annular member is reduced when a load is received by the contact surface,
a guide surface is formed on the part of the inside surface of the shaft cylinder, the guide surface being configured to come into contact with the contact surface in conjunction with the movement of the tip holder toward the front end side, and
the contact surface is configured to receive the load from the guide surface in conjunction with the movement of the tip holder toward the front end side.

2. The projectable and retractable writing tool according to claim 1, wherein
the cutout is a plurality of cutout elements arranged at regular intervals in a circumferential direction of the annular member, and
each of the plurality of cutout elements is a slit extending in an axial direction of the annular member.

3. The projectable and retractable writing tool according to claim 1, wherein
the contact surface has a tapered shape toward the front end side, and
the guide surface also has a tapered shape toward the front end side.

4. The projectable and retractable writing tool according to claim 3, wherein
the contact surface has a frustoconical surface.

5. (canceled)

6. The projectable and retractable writing tool according to any claim 1, wherein
the elastic member is a tubular resin spring member having a lot of splits each of which extends in a direction perpendicular to the axial direction.

7. (canceled)

8. (canceled)

9. (canceled)

10. A shaft cylinder for a projectable and retractable writing tool, the shaft cylinder being capable of containing a tip holder such that the tip holder is movable in an axial direction, a tip being fixed to a front end of the tip holder, the shaft cylinder having an opening at a front end thereof, through which the tip is projectable and retractable in conjunction with a movement of the tip holder, the shaft cylinder comprising,
an annular member loosely fitted onto an outer periphery of the tip holder or the tip in a state wherein the shaft cylinder contains the tip holder, to be movable in an axial direction of the tip holder or the tip with respect to the tip holder or the tip while being loosely fitted,
an annular collar connected to the annular member via an elastic member, the annular collar being capable of coming into contact with the tip holder in conjunction with a movement of the tip holder toward a front end side thereof, and
a second elastic member configured to support the annular collar on an inside surface of the shaft cylinder,
wherein
a contact surface is formed on at least a part of an outer periphery of the annular member, the contact surface being configured to come into contact with a part of the inside surface of the shaft cylinder in conjunction with the movement of the tip holder toward the front end side,
a cutout is formed at a part of the annular member such that an inner diameter of the annular member is reduced when a load is received by the contact surface,
a guide surface is formed on the part of the inside surface of the shaft cylinder, the guide surface being configured to come into contact with the contact surface in conjunction with the movement of the tip holder toward the front end side, and
the contact surface is configured to receive the load from the guide surface in conjunction with the movement of the tip holder toward the front end side.

11. The shaft cylinder for a projectable and retractable writing tool according to claim 10, wherein
the cutout is a plurality of cutout elements arranged at regular intervals in a circumferential direction of the annular member, and
each of the plurality of cutout elements is a slit extending in an axial direction of the annular member.

12. The shaft cylinder for a projectable and retractable writing tool according to claim 10, wherein
the contact surface has a tapered shape toward the front end side, and
the guide surface also has a tapered shape toward the front end side.

13. (canceled)

14. (canceled)

15. (canceled)

16. (canceled)

17. (canceled)

18. A multi-tip writing tool comprising:
a shaft cylinder having an opening at a front end thereof,
a plurality of tip holders contained in an inside of the shaft cylinder and movable in an axial direction of the shaft cylinder,
a tip fixed to a front end of each of the plurality of tip holders to be projectable and retractable through the opening of the shaft cylinder in conjunction with a movement of the corresponding tip holder,
an annular member loosely fitted onto an outer periphery of each tip or each tip holder fixed to each tip to be movable in an axial direction of the tip with respect to the tip, and
an elastic member connecting the tip holder and the annular member such that the tip holder and the annular member are movable relatively to each other,
wherein
a contact surface is formed on at least a part of an outer periphery of the annular member, the contact surface being configured to come into contact with a part of an inside surface of the shaft cylinder in conjunction with a movement of the tip holder connected to the annular member toward a front end side thereof,
a cutout is formed at a part of the annular member such that an inner diameter of the annular member is reduced when a load is received by the contact surface,
a guide surface is formed on the part of the inside surface of the shaft cylinder, the guide surface being configured to come into contact with the contact surface in conjunction with the movement of the tip holder toward the front end side, and
the contact surface is configured to receive the load from the guide surface in conjunction with the movement of the tip holder connected to the annular member having the contact surface toward the front end side.

19. The multi-tip writing tool according to claim 18, wherein
the cutout is a plurality of cutout elements arranged at regular intervals in a circumferential direction of the annular member, and
each of the plurality of cutout elements is .a slit extending in an axial direction of the annular member.

20. The multi-tip writing tool according to claim 18, wherein
the contact surface has a tapered shape toward the front end side, and
the guide surface also has a tapered shape toward the front end side.

21. The multi-tip writing tool according to claim 20, wherein the contact surface has a frustoconical surface.

22. The multi-tip writing tool according to claim 18, wherein
the elastic member is a tubular resin spring member having a lot of splits each of which extends in a direction perpendicular to the axial direction.

23. (canceled)

24. (canceled)

25. (canceled)

26. A multi-tip writing tool comprising:
a shaft cylinder having an opening at a front end thereof,
a plurality of tip holders contained in an inside of the shaft cylinder and movable in an axial direction of the shaft cylinder,
a tip fixed to a front end of each of the plurality of tip holders to be projectable and retractable through the opening of the shaft cylinder in conjunction with a movement of the corresponding tip holder,
an annular member capable of being loosely fitted on an outer periphery of one tip holder among the plurality of tip holders or one tip fixed to the one tip holder in conjunction with a movement of the one tip holder toward a front end side thereof to be movable in an axial direction of the one tip holder or the one tip with respect to the one tip holder or the one tip while being loosely fitted,
an annular collar connected to the annular member via an elastic member, the annular collar being capable of coming into contact with the one tip holder in conjunction with the movement of the one tip holder toward the front end side, and
a second elastic member configured to support the annular collar on an inside surface of the shaft cylinder,
wherein
a contact surface is formed on at least a part of an outer periphery of the annular member, the contact surface being configured to come into contact with a part of an inside surface of the shaft cylinder when the annular member is moved toward the front end side via the annular collar and the elastic member in conjunction with the movement of the one tip holder toward the front end side,
a cutout is formed at a part of the annular member such that an inner diameter of the annular member is reduced when a load is received by the contact surface,
a guide surface is formed on the part of the inside surface of the shaft cylinder, the guide surface being configured to come into contact with the contact surface in conjunction with the movement of the one tip holder toward the front end side, and
the contact surface is configured to receive the load from the guide surface when the annular member is moved toward the front end side via the annular collar and the elastic member in conjunction with the movement of the one tip holder toward the front end side.

27. The multi-tip writing tool according to claim 26, wherein
the cutout is a plurality of cutout elements arranged at regular intervals in a circumferential direction of the annular member, and
each of the plurality of cutout elements is a slit extending in an axial direction of the annular member.

28. The multi-tip writing tool according to claim 26, wherein
the contact surface has a tapered shape toward the front end side, and
the guide surface also has a tapered shape toward the front end side.

29. The multi-tip writing tool according to claim 28, wherein the contact surface has a frustoconical surface.

30. The multi-tip writing tool according to claim 26, wherein
the elastic member is a tubular resin spring member having a lot of splits each of which extends in a direction perpendicular to the axial direction.

31. (canceled)

32. A shaft cylinder for a multi-tip writing tool, the shaft cylinder being capable of containing a plurality of tip holders such that each tip holder is movable in an axial direction, a tip being fixed to a front end of each tip holder, the shaft cylinder having an opening at a front end thereof, through which a tip fixed to one tip holder among the plurality of tip holders is projectable and retractable in conjunction with a movement of the one tip holder, the shaft cylinder comprising,
an annular member capable of being loosely fitted on an outer periphery of one tip holder among the plurality of tip holders or one tip fixed to the one tip holder in conjunction with a movement of the one tip holder toward a front end side thereof to be movable in an axial direction of the one tip holder or the one tip with respect to the one tip holder or the one tip while being loosely fitted,
an annular collar connected to the annular member via an elastic member, the annular collar being capable of coming into contact with the one tip holder in conjunction with the movement of the one tip holder toward the front end side, and
a second elastic member configured to support the annular collar on an inside surface of the shaft cylinder,
wherein
a contact surface is formed on at least a part of an outer periphery of the annular member, the contact surface being configured to come into contact with a part of an inside surface of the shaft cylinder when the annular member is moved toward the front end side via the annular collar and the elastic member in conjunction with the movement of the one tip holder toward the front end side,
a cutout is formed at a part of the annular member such that an inner diameter of the annular member is reduced when a load is received by the contact surface,
a guide surface is formed on the part of the inside surface of the shaft cylinder, the guide surface being configured to come into contact with the contact surface in conjunction with the movement of the one tip holder toward the front end side, and
the contact surface is configured to receive the load from the guide surface when the annular member is moved toward the front end side via the annular collar and the elastic member in conjunction with the movement of the one tip holder toward the front end side.

33. The shaft cylinder for a multi-tip writing tool according to claim 32, wherein
the cutout is a plurality of cutout elements arranged at regular intervals in a circumferential direction of the annular member, and
each of the plurality of cutout elements is a slit extending in an axial direction of the annular member.

34. The shaft cylinder for a multi-tip writing tool according to claim 32, wherein
the contact surface has a tapered shape toward the front end side, and
the guide surface also has a tapered shape toward the front end side.

35. (canceled)

36. (canceled)

37. (canceled)
